(19) United States
(12) Patent Application Publication
(10) Pub. No.: US 2024/0239956 A1
(43) Pub. Date: Jul. 18, 2024

(54) BIODEGRADABLE ELASTOMERIC COMPOSITIONS AND METHODS OF MAKING THE SAME

(71) Applicants: Alliance for Sustainable Energy, LLC, Golden, CO (US); Colorado State University Research Foundation, Fort Collins, CO (US)

(72) Inventors: Nicholas A. RORRER, Golden, CO (US); Gregg Tyler BECKHAM, Golden, CO (US); Robin Marcelle CYWAR, Denver, CO (US); Robert David ALLEN, Golden, CO (US); Ryan William CLARKE, Wheat Ridge, CO (US); Gloria ROSETTO, Lakewood, CO (US)

(21) Appl. No.: 18/529,459

(22) Filed: Dec. 5, 2023

Related U.S. Application Data
(60) Provisional application No. 63/386,011, filed on Dec. 5, 2022.
(60) Provisional application No. 63/519,950, filed on Aug. 16, 2023.

(51) Int. Cl. C08G 63/698; C08G 63/688

(52) U.S. Cl. CPC C08G 63/698; C08G 63/688

(57) ABSTRACT

The present disclosure relates to a composition that includes a first copolymer having a first repeat unit and a second repeat unit as defined by Structure (I)

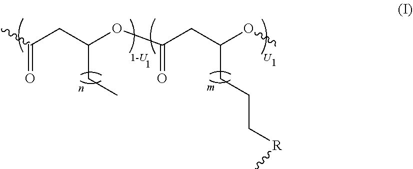

where [symbol] is a covalent bond, U₁ is a molar fraction of the first repeat unit, (1−U₁) is a molar fraction of the second repeat unit, 0≤n≤20, 0≤m≤20, 0<U₁≤1.0, R is a linking group covalently linking the first copolymer to a second copolymer by the covalent bond, and R includes carbon, hydrogen, and sulfur.

### CROSS-REFERENCE TO RELATED APPLICATIONS

This application claims priority from U.S. Provisional Patent Application Nos. 63/386,011 and 63/519,950 filed on Dec. 5, 2022 and Aug. 16, 2023, respectively, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Thermoset polymers are crosslinked materials which include elastomers (rubbers) and contribute to synthetic polymer pollution due to their non-recyclable and non-biodegradable nature. Butadiene and natural rubbers comprise the largest commodity rubbers. Although bio-derived, vulcanized natural rubber from polyisoprene is neither biodegradable nor environmentally friendly to produce. Polyhydroxyalkanoates (PHAs) are natural polyesters synthesized by microorganisms for energy and carbon storage and offer the possibility of generating recyclable, bioderived thermoset polymers. Thus, there is the potential for PHAs in conjunction with suitable crosslinkers to produce economically viable, environmentally friendly bioderived thermoset polymers and resins. However, there remains a need for systems and methods that enable the production of PHA-derived thermoset polymers and resins having specific, targeted physical properties and/or performance metrics over a range that is useful for a variety of applications.

### SUMMARY

An aspect of the present disclosure is a composition that includes a first copolymer having a first repeat unit and a second repeat unit as defined by Structure (I)

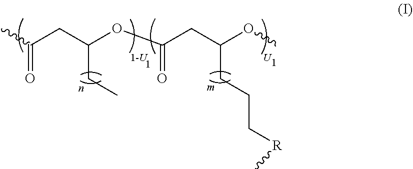

where [symbol] is a covalent bond, U₁ is a molar fraction of the first repeat unit (unsaturated), (1−U₁) is a molar fraction of the second repeat unit (saturated), 0≤n≤20, 0≤m≤20, 0<U₁≤1.0, R is a linking group covalently linking the first copolymer to a second copolymer by the covalent bond, and R includes carbon, hydrogen, and sulfur.

In some embodiments of the present disclosure, the first copolymer may have a molecular weight (Mₙ) between 100 kDa and 1000 kDa. In some embodiments of the present disclosure, n may be between 0 and 9, inclusively. In some embodiments of the present disclosure, m may be between 0 and 9, inclusively. In some embodiments of the present disclosure, 0.01<U₁<0.50. In some embodiments of the present disclosure, the first copolymer may be derived from poly-R-(3-hydroxydecanonate-co-3-hydroxyundecenoate) (PHDU).

In some embodiments of the present disclosure, R may further include at least one of oxygen and/or boron. In some embodiments of the present disclosure, R may include at least one of

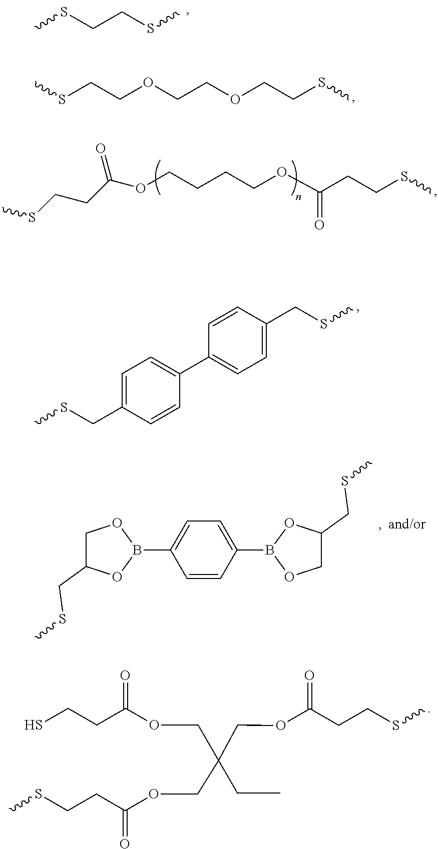

In some embodiments of the present disclosure, R is

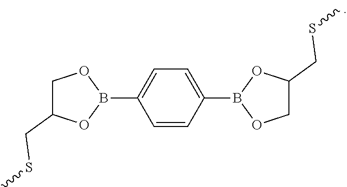

In some embodiments of the present disclosure, the second copolymer may include Structure (I). In some embodiments of the present disclosure, the second copolymer may include Structure (II)

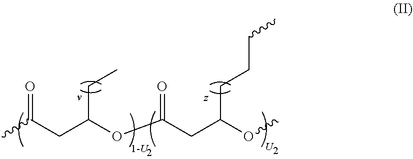

where U₂ is a molar fraction of a third repeat unit, (1−U₂) is a molar fraction of a fourth repeat unit, 0≤v≤20, 0≤z≤20, and 0<U₂≤1. In some embodiments of the present disclosure, v may be between 0 and 9, inclusively. In some embodiments of the present disclosure, z may be between 0 and 9, inclusively. In some embodiments of the present disclosure, 0.01<U₂<0.50. In some embodiments of the present disclosure, the second copolymer chain may be derived from (poly-(R)-3-hydroxyburytate-co-3-hydroxyundecanoate (PHBU).

In some embodiments of the present disclosure, the first copolymer and the second copolymer may be at a mass ratio between 1:10 and 10:1 (first copolymer:second copolymer), inclusively. In some embodiments of the present disclosure, the ratio may be between 1:3 and 3:1, inclusively. In some embodiments of the present disclosure, the composition may be elastomeric. In some embodiments of the present disclosure, the composition may further include a glass transition temperature (T_{g}) between −50° C. and 10° C. In some embodiments of the present disclosure, the composition may further include a melting temperature (Tₘ) between 40° C. and 180° C. In some embodiments of the present disclosure, the composition may further include a Young's modulus (E) between 1 MPa and 1000 MPa. In some embodiments of the present disclosure, the composition may further include a ductility (ε_{B}) between 1% and 500%. In some embodiments of the present disclosure, the composition may further include a strength at break (σ_{B}) between 0.1 MPa and 20 MPa. In some embodiments of the present disclosure, the composition may further include an onset of degradation temperature (T_{d,5}) between 260° C. and 300° C.

In some embodiments of the present disclosure, the composition may be biodegradable. In some embodiments of the present disclosure, the composition may further include a freshwater percent biodegradation at 90 days between 21% and 40%. In some embodiments of the present disclosure, the composition may further include the absence of phase separation as determined by scanning electron microscopy (SEM).

An aspect of the present disclosure is a method that includes reacting a mixture comprising a first copolymer, a second copolymer, and a crosslinker to form a biodegradable elastomeric resin.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates an exemplary reaction of a first polyhydroxyalkanoate, (PHBU), with a second polyhydroxyalkanoate, (PHDU), and a crosslinker to form a polymer and/or resin having properties of a thermoset, according to some embodiments of the present disclosure.

FIG. 2A illustrates an ¹H nuclear magnetic resonance (NMR) (CDCl₃) spectrum of pooled PHDU-6 (definitions of PHDU-6, etc., provided below), according to some embodiments of the present disclosure.

FIG. 2B illustrates an ¹H NMR (CDCl₃) spectrum of pooled PHDU-22, according to some embodiments of the present disclosure.

FIG. 3A illustrates an Fourier transform infrared (FTIR) spectrum of PHDU-6, according to some embodiments of the present disclosure.

FIG. 3B illustrates an FTIR spectrum of PHDU-22, according to some embodiments of the present disclosure.

FIG. 4A illustrates a thermogravimetric analysis (TGA) profile of PHDU-6, according to some embodiments of the present disclosure.

FIG. 4B illustrates a TGA profile of PHDU-22, according to some embodiments of the present disclosure.

FIG. 5 illustrates thermal and tensile characterization of linear PHDU-6, according to some embodiments of the present disclosure. Panels A-C illustrate crystallization behavior of PHDU-6 under various DSC conditions (exothermic is up). For Panels B and C, the reported enthalpy is the integration of the larger Tₘ peak. Panel D illustrates a DSC trace of a solvent-cast thin film of PHDU-6. Panel E illustrates a tensile profile of linear PHDU PHA (n=3 specimens) and Panel F illustrates a photograph of tensile dog-bone shaped specimen

FIG. 6A illustrates a differential scanning calorimetry (DSC) profile of PHDU-6 with a 14 hour isothermal hold (10° C./min heat), according to some embodiments of the present disclosure.

FIG. 6B illustrates a DSC profile of PHDU-6 ‘as precipitated’ from ethanol, according to some embodiments of the present disclosure.

FIG. 6C illustrates DSC profiles of PHDU-22 at 1, 5, and 10° C./min cooling and heating rates (second cycles shown), according to some embodiments of the present disclosure.

FIG. 7 illustrates an ¹H NMR (DMSO-d₆) spectrum of Bis-BE-SH crosslinker, according to some embodiments of the present disclosure.

FIG. 8A illustrates an FTIR overlay of PHDU-6 and PHDU-BE-6, according to some embodiments of the present disclosure. New signals at 1518.16, 1404.60, 1362.87, 1266.23, 1024.10, and 656.57 cm⁻¹ correspond to boronic ester incorporation.

FIG. 8B illustrates an FTIR overlay of PHDU-22 and PHDU-BE-22, according to some embodiments of the present disclosure.

FIGS. 9A-D illustrate various aspects of the present disclosure: FIG. 8A illustrates a TGA profile of PHDU-TE-6; FIG. 8B illustrates a DSC profile of PHDU-TE-6 (10° C./min cooling and heating); FIG. 8C illustrates a TGA profile of PHDU-TE-22; and FIG. 8D illustrates a DSC profile of PHDU-TE-22 (10° C./min cooling and heating), all according to some embodiments of the present disclosure.

FIG. 10 illustrates photographs of PHDU-TE-6 and 22% samples showing incomplete welding after attempted thermal processing, according to some embodiments of the present disclosure.

FIG. 11A-D illustrate various aspects of the present disclosure: FIG. 11A illustrates a DSC profile of PHDU-BPh-6 (10° C./min cooling and heating); FIG. 11B illustrates a TGA profile of PHDU-BPh-6; FIG. 11C illustrates a DSC profile of PHDU-BPh-22 (10° C./min cooling and heating); and FIG. 11D illustrates a TGA profile of PHDU-BPh-22, all according to some embodiments of the present disclosure.

FIGS. 12A-D illustrate various aspects of the present disclosure: FIG. 11A illustrates a TGA profile of PHDU-BE-6, 1-gram scale; FIG. 11B illustrates a TGA profile of PHDU-BE-6, 3-gram scale; FIG. 11C illustrates a DSC profile of PHDU-BE-6, 1-gram scale (10° C./min cooling and heating, second cycle); and FIG. 11D illustrates a DSC profile of PHDU-BE-6, 3-gram scale (10° C./min cooling and heating), all according to some embodiments of the present disclosure.

FIG. 13A illustrates a TGA profile of PHDU-BE-22, 3-gram scale (10° C./min cooling and heating, second cycle), according to some embodiments of the present disclosure.

FIG. 13B illustrates a DSC profile of PHDU-BE-22, 3-gram scale (10° C./min cooling and heating, second cycle), according to some embodiments of the present disclosure.

FIG. 14A illustrates an overlay of TGA profiles of PHDU-BE-6 and PHDU-12 that was crosslinked with half Bis-BE-SH and half ethanethiol (PHDU-12_6BE-6EtSH), according to some embodiments of the present disclosure.

FIG. 14B illustrates an overlay of DSC profiles of PHDU-BE-6 and PHDU-12 that was crosslinked with half Bis-BE-SH and half ethanethiol (10° C./min cooling and heating, second cycles shown), according to some embodiments of the present disclosure.

FIG. 15 illustrates results from an aging study of PHDU-BE-6 (8 mm-wide disc, compression molded and stored in a glass vial), according to some embodiments of the present disclosure.

FIG. 16 illustrates: Panel A DMA data showing storage modulus versus temperature for PHDU-6 and PHDU-BE-6; Panel B an overlay of tensile profiles for PHDU-BE-6 processed four times with a 1-week aging period between processing and testing (n=3); Panel C elastic hysteresis test results of PHDU-BE-6 with 1-week aging period between processing and testing; and Panel D a photo illustrating reprocessability of PHDU-BE-6, according to some embodiments of the present disclosure.

FIG. 17 illustrates an ¹H NMR spectrum (DMSO-d₆) of white bloom found on the surface of PHDU-BE-6 after 3 months of storage in an LDPE bag (top), overlaid with a commercial sample (bottom), according to some embodiments of the present disclosure.

FIGS. 18 illustrates stress-strain curves for PHDU-BE-6 (aged one week with desiccant after thermal processing; amorphous, n=3), according to some embodiments of the present disclosure. The specimen which broke at ˜800% strain incurred a small cut when removed from its mold.

FIG. 19 illustrates a DSC profile of PHDU-BE-6 tensile specimen after tensile testing, according to some embodiments of the present disclosure.

FIG. 20 illustrates the tensile properties of semicrystalline and amorphous PHDU-BE-6 mapped against the linear parent, according to some embodiments of the present disclosure.

FIG. 21 illustrates stress-strain curves for PHDU-BE-22 (two processing cycles, n=2 as the 3^{rd} specimens tore while removing from its mold), according to some embodiments of the present disclosure.

FIG. 22 illustrates a plot of viscosity versus shear rate at 175° C. for PHDU-BE-6, according to some embodiments of the present disclosure.

FIG. 23 illustrates an ¹H NMR spectrum (CDCl₃) of PHDU-BE-6 after diolysis with 1,2-propanediol, according to some embodiments of the present disclosure.

FIG. 24 illustrates freshwater biodegradation results (as measured according to ISO 14851) for linear PHDU-6 and PHDU-BE-6 against a glucose control, according to some embodiments of the present disclosure.

FIG. 25 illustrates a cartoon representation of a PHDU-BE network (left) with chain entanglements, crystallites, closed and open BE linkages (left), and (right) an interplay among moisture, crosslink density, crystallization, and mechanical properties, according to some embodiments of the present disclosure.

FIG. 26A illustrates a DSC trace showing the thermal and tensile characterization of linear PHBU-4, according to some embodiments of the present disclosure.

FIG. 26B illustrates a DSC trace showing the thermal and tensile characterization of crosslinked PHBU-BE-4, according to some embodiments of the present disclosure.

FIG. 27 illustrates an ¹H NMR (400 MHz, CDCl₃) spectrum of PHBU and the calculation of for U as a molar percentage, according to some embodiments of the present disclosure.

FIG. 28 illustrates a ¹³C{¹H} NMR (CDCl3, 101 MHz) spectrum of PHBU-5, according to some embodiments of the present disclosure.

FIG. 29 illustrates a GPC trace of PHBU-5, according to some embodiments of the present disclosure.

FIG. 30 illustrates aspects for preparing and analyzing compatibilized PHBU and PHDU blends by dynamic crosslinking, according to some embodiments of the present disclosure. Panel A) illustrates a general scheme for the simultaneous blending and resulting blend compatibilization by dynamic crosslinking between scl-co-mcl and mcl-co-mcl usPHAs using thiol-ene click chemistry to produce homogenized copolymer networks. Panel B) illustrates normalized DSC heat flow (10° C. min⁻¹, exo-up) traces. Panel C) illustrates dynamic mechanical analysis (DMA) temperature-ramp frequency sweep (−80 to 175 or 200° C., 3° C. min⁻¹, 30 μm, 1 Hz) thermograms. Panel D) illustrates tensile stress/strain tests (5 mm min⁻¹, ˜23° C.) for homopolymer PHBU (black) and PHBU-PHDU blends at input ratios of 3:1 (blue), 1:1 (orange), and 1:3 (purple). Panel E) illustrates SEM cross-sectional imaging of all virgin (top) and dynamic crosslinking compatibilized (bottom) scl-co-mcl and mcl-co-mcl usPHA blends (scale bar=30 μm).

FIG. 31 illustrates DSC trace (second heating scan) of PHBU-5 (-80° C. to 200° C., 10° C. min⁻¹), according to some embodiments of the present disclosure.

FIG. 32 (S11) illustrates individual DMA thermograms for Panel A) PHBU-5, Panel B) PHBU₃-blend-PHDU₁ Panel C) PHBU₁-blend-PHDU₁, and Panel D) PHBU₁-blend-PHDU₃, according to some embodiments of the present disclosure.

FIG. 33 illustrates individual stress/strain curves (˜23° C., 5 mm min⁻¹) for Panel A) PHBU-5, Panel B) PHBU₃-blend-PHDU₁ Panel C) PHBU₁-blend-PHDU₁ and Panel D) PHBU₁-blend-PHDU₃, according to some embodiments of the present disclosure.

FIG. 34 illustrates TGA graphs of PHBU-5 and boronic ester cross-linked blends, according to some embodiments of the present disclosure.

FIG. 35 illustrates SEM images of film cross-sections for virgin (top) and compatibilized (bottom) PHBU₁-blend-PHDU₃, according to some embodiments of the present disclosure.

FIG. 36 illustrates SEM images of film cross-sections for virgin (top) and compatibilized (bottom) PHBU₁-blend-PHDU₁, according to some embodiments of the present disclosure.

FIG. 37 illustrates SEM images of film cross-sections for virgin (top) and compatibilized (bottom) PHBU₃-blend-PHDU₁, according to some embodiments of the present disclosure.

FIG. 38 illustrates droplet diameter analysis results for PHBU₁-blend-PHDU₃ cross-sectional images, according to some embodiments of the present disclosure.

FIG. 39 illustrates droplet diameter analysis results for PHBU₁-blend-PHDU₁ cross-sectional images, according to some embodiments of the present disclosure.

FIG. 40 illustrates droplet diameter analysis results for PHBU₃-blend-PHDU₁ cross-sectional images, according to some embodiments of the present disclosure.

FIG. 41 illustrates results from cyclic deformation experiments on: Panel A) hard-rubber (PHBU₃:PHDU₁); Panel B) firm plastic-like (PHBU₁:PHDU₁); and Panel C) soft-elastomer materials generated from varied blending components compatibilized by dynamic crosslinker (50 mm/min up-ramp, 50 mm/min down-ramp, 23°C.), according to some embodiments of the present disclosure.

FIG. 42 illustrates biodegradability results from freshwater biodegradation experiment, according to some embodiments of the present disclosure. Freshwater biodegradation of PHBU-5, PHBUₛₐₜ-4, PHBU₁-blend-PHDU₃, and PHBU₃-blend-PHDU₁ in freshwater environments. Results over a 107-day period of aerobic freshwater degradation (ISO 14851) for PHBU-5 (red), PHBUₛₐₜ-4 (grey), PHBU₁-blend-PHDU₃ (yellow), and PHBU₃-blend-PHDU₁ (blue) against a microcrystalline cellulose control (MCC, black).

FIG. 43 illustrates a TGA thermogram of PHBU films post freshwater biodegradation, according to some embodiments of the present disclosure.

FIG. 44 illustrates FTIR spectra of PHBU₁-blend-PHDU₃ and PHBU₃-blend-PHDU₁ blends before and after freshwater biodegradation, and the subtraction, according to some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present disclosure describes the use of PHAs, for example, medium chain length (mcl) unsaturated (us) PHAs (abbreviated herein as mcl-usPHAs) and thiol-ene crosslinking chemistry to manufacture thermosets that are both re-processable and biodegradable. “Medium chain length” refers to an unsaturated chain having between 1 and 20 carbon atoms, or between 5 and 9 carbon atoms. The effects of dynamic crosslinking on the thermomechanical and rheological material properties of the resultant cross-linked materials were studied with a goal of uncovering design principles for further material development towards targeted applications. In some embodiments of the present disclosure, a relatively soft and semicrystalline unsaturated PHA (usPHA) poly-R-(3-hydroxydecanonate-co-3-hydroxyundecenoate) (PHDU) was utilized to produce networks having both low and high crosslinking densities. The structure of PHDU is shown below as Structure I, where U is the mole fraction of its bracketed repeat unit and (1−U) is the mole fraction of its bracketed repeat unit (more details on these metrics follow below).

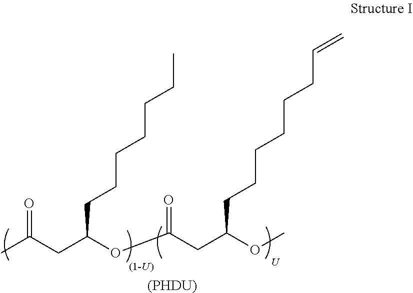

Structure-property relationships and end-of-life scenarios were evaluated for these PHDU-derived vitrimers. As defined herein vitrimers are permanent yet dynamic polymer networks (i.e., resins) that ideally behave like conventional thermosets at service temperatures, but flow like vitreous glasses at processing temperatures. Thus, a vitrimer is a subset of a thermoset.

Thus, the present disclosure more generally relates to compositions, such as polymers and/or polymer networks and resins, that have at least some of the properties and/or performance metrics that typically characterize thermoset polymers and/or plastics. In some embodiments of the present disclosure, a resin having thermoset properties may include a structure as defined by Structure II-a, below. In general, Structure II-a is a crosslinked structure having at least two copolymer chains connected by a linking group R. The copolymer chains may be PHAs having a first repeat unit having unsaturated hydrocarbon sidechains, e.g., vinyl-terminated hydrocarbon chains, and a second repeat unit having saturated hydrocarbon sidechains.

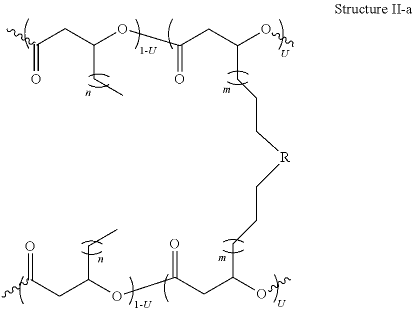

Referring to Structure II-a, [symbol] represents a covalent bond, each of n and m are independently between 1 and 20, inclusively, corresponding to the number of repeat units of the —CH₂— group. In some embodiments of the present disclosure, n may be between 2 and 20 or between 5 and 9, inclusively. In some embodiments of the present disclosure, m may be between 2 and 20 or between 5 and 9, inclusively. U represents the molar fraction of the crosslinked first unsaturated repeat unit contained in the resin. The difference of 1−U represents the mole fraction of the saturated repeat unit contained in the resin. So, when U is zero, no crosslinking is possible, with the amount of possible crosslinking increasing as U increases to a maximum of 1.0. As shown herein, 0.0<U≤1.0, 0.01≤U≤0.5, or 0.05≤U≤0.25. R represents a linking group that includes at least one of sulfur, carbon, and/or hydrogen. In some embodiments of the present disclosure, R may include at least one of sulfur, carbon, hydrogen, nitrogen, oxygen, and/or boron. Thus, referring again to Structure II-a, the exemplary structure illustrates two copolymer chains. However, this is shown for illustrative purposes and is not meant to be limiting. In some embodiments of the present disclosure, resin compositions may have two or polymer chains crosslinked by two or more linking groups, R.

Referring again to Structure II-a, the amount of reacted first unsaturated repeat unit is indicated by U and the mole fraction of the second saturated repeat unit is represented by 1−U. However, complete reaction of the first unsaturated repeat unit may not always be possible. Therefore, in some embodiments of the present disclosure, a polymer network like that illustrated in Structure II-b may include a third a third repeat unit, the unreacted form of the first unsaturated repeat unit, resulting in Structure II-b:

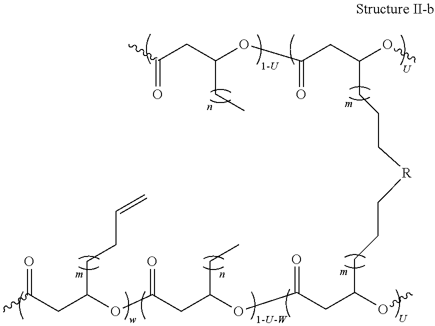

where U is the mole fraction of the reacted unsaturated repeat unit, W is the mole fraction of the mole fraction of the unreacted unsaturated repeat unit, and 1−U−W is the mole fraction of saturated repeat unit. Note that the top polymer chain of Structure II-b is illustrated with only reacted unsaturated repeat units. This is for illustrative purposes. In some embodiments of the present disclosure, any of the crosslinked polymer chains may contain between zero and completely reacted unsaturated repeat units; e.g., 0≤W<1. In most cases, the unsaturated repeat unit reacts such that W approaches zero or is equal to zero; e.g., 0≤W<0.1 or 0≤W<0.01.

Specific examples of linking groups, R, are shown in Scheme I. These examples are not intended to be limiting and other linking groups having similar structures and/or compositions are considered to fall within the scope of the present disclosure.

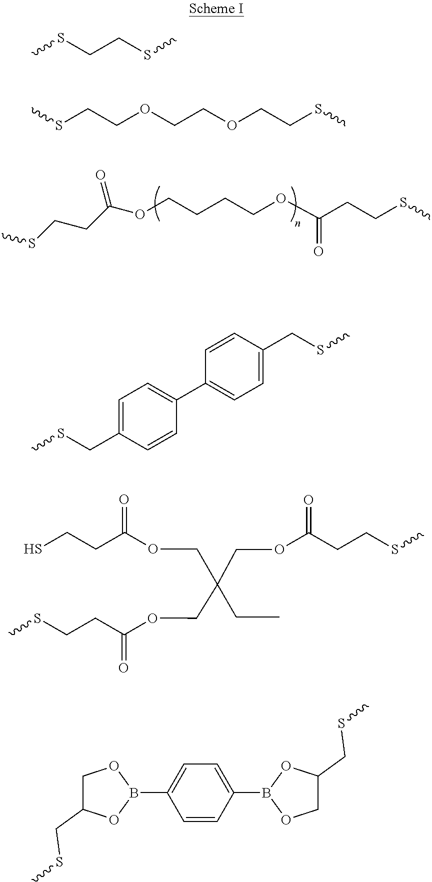

In some embodiments of the present disclosure, R may be derived from a crosslinker that is a di-thiol and/or poly-thiol. An example of a di-thiol-containing crosslinker includes 2,2′-(1,4-phenylene)-bis[4-thioethyl-1,3,2-dioxaborolane, abbreviated herein as Bis-BE-SH, with its structure shown below as Structure III. As shown herein, use of this crosslinker results in re-processable vitrimer resins.

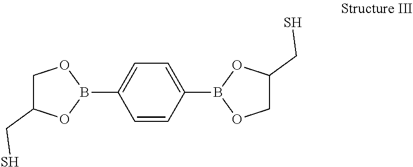 [SMILES: SCC1COB(c2ccc(B3OCC(CS)O3)cc2)O1]

As shown herein, Bis-BE-SH may be reacted with PHAs, for example, poly-R-(3-hydroxydecanonate-co-3-hydroxyundecenoate) (PHDU), a relatively soft PHA, to form the exemplary re-processable thermoset illustrated below in Scheme II, where U may be between greater than zero and less than or equal to one.

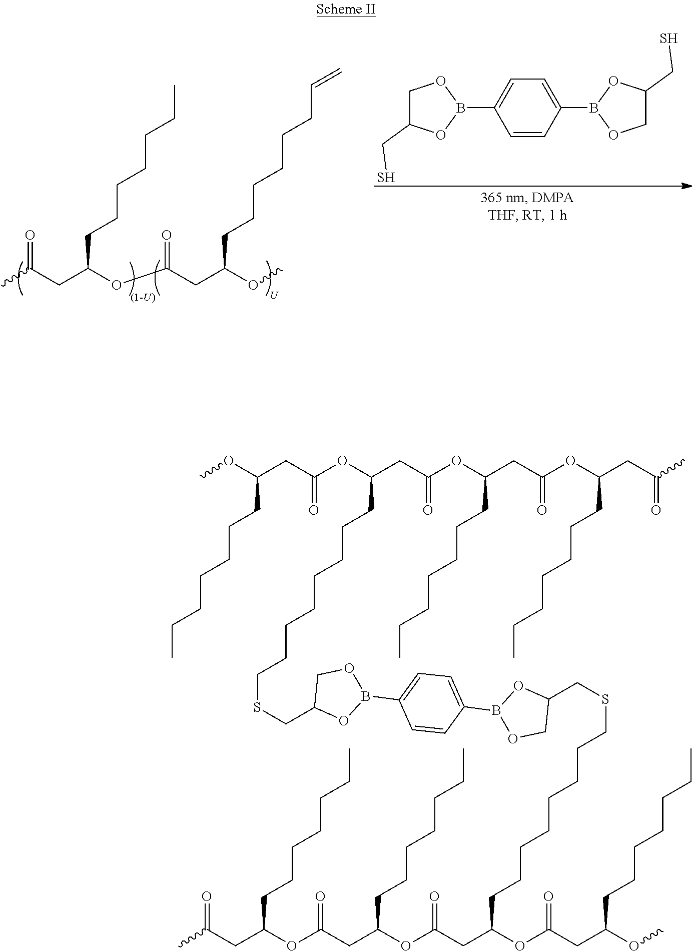

In general, the reaction illustrated in Scheme II for PHDU was performed as described below. A 250 mL flat-bottom flask with a stir bar was loaded with 3.0 g PHDU-6 (U≈0.06 molar fraction) (1.05 mmol alkene), 150 mL anhydrous THF, and Bis-BE-SH (816 mg Bis-BE-SH, 2.63 mmol, 5 equiv. SH:ene). Once dissolved, a 0.5 wt % loading of 2,2-dimethoxy-2-phenylacetophenone (DMPA) photoinitiator (2,2-Dimethoxy-2-phenylacetophenone) relative to polymer (15 mg) was added and the flask sealed with a rubber septum. The flask was transferred to a photoreactor and irradiated at 365 nm for 1 hour with vigorous stirring (˜600 rpm) and air cooling (e.g., using air at room temperature, or about 22° C.). After reaction, most of the THF was removed by rotary evaporation and the crude product was washed with anhydrous methanol (80-100 mL total), then dried in a vacuum oven at 37° C. for 24 hours. A larger scale manufacturing process would ideally be solvent-free and take place in-situ, e.g., using reactive injection molding, where molten polymer is well-mixed with radical initiator and crosslinker molecules.

Another starting PHA that was tested and is described herein is illustrated below, Structure IV, (poly-(R)-3-hydroxyburytate-co-3-hydroxyundecanoate (PHBU), which is a relatively hard PHA, compared to PHDU.

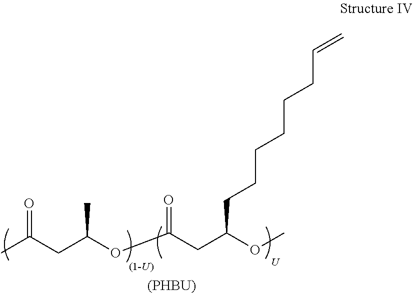

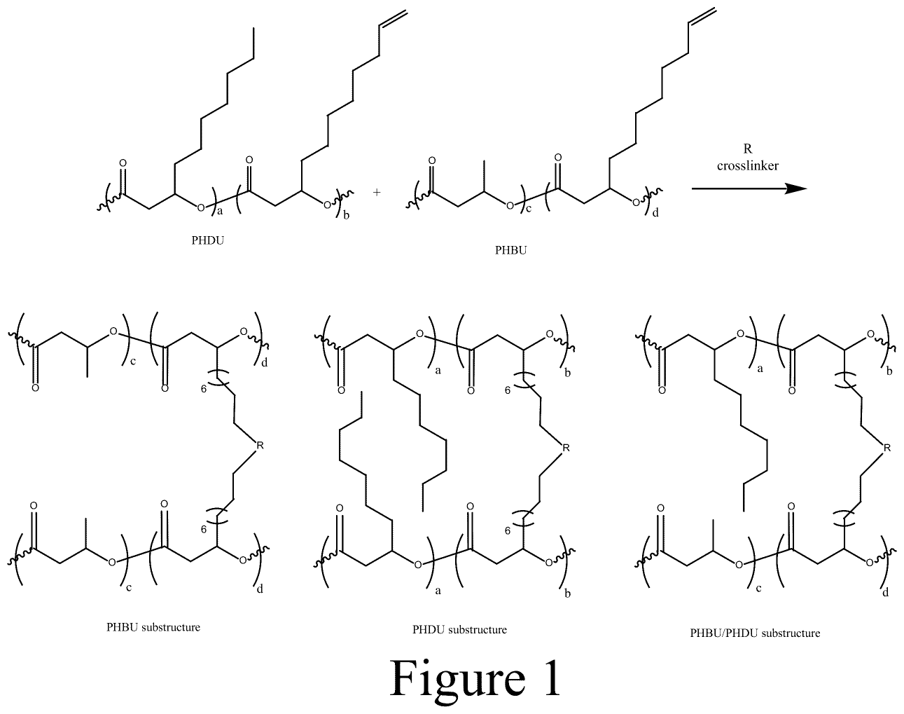

As shown herein, the same and/or different PHAs may be combined in a reaction mixture and reacted with a crosslinker to synthesize crosslinked polymer networks, i.e., resins, having specific, tunable physical properties and/or performance metrics. For example, as shown herein, relatively hard PHBU may be combined with relatively soft PHDU and reacted with Bis-BE-SH to form an elastomer-like thermoset having physical properties between those attainable using only PHDU or only PHBU. FIG. 1 illustrates this exemplary reaction of reacting PHDU and PHBU using a generic crosslinker, R. Referring to FIG. 1, the reaction of PHDU with PHBU may result in a crosslinked polymer network having three different distinguishable substructures. The first substructure, referred to in FIG. 1 as the “PHBU substructure” results from two PHBU polymers crosslinking. The second substructure, the “PHDU substructure” results from two PHDU polymers crosslinking. The third substructure, the “PHBU/PHDU substructures” results from a PHDU polymer crosslinking with a PHBU polymer. Generic representations of these three substructures are illustrated in Schemes III-a and III-b below, in terms of mole fractions of repeat units and number of repeat units, respectively.

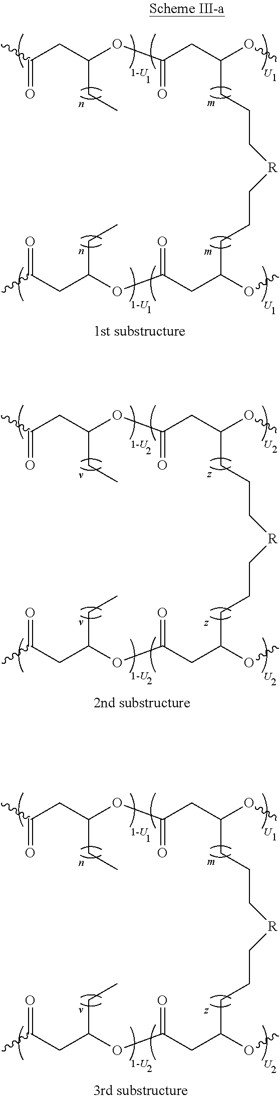

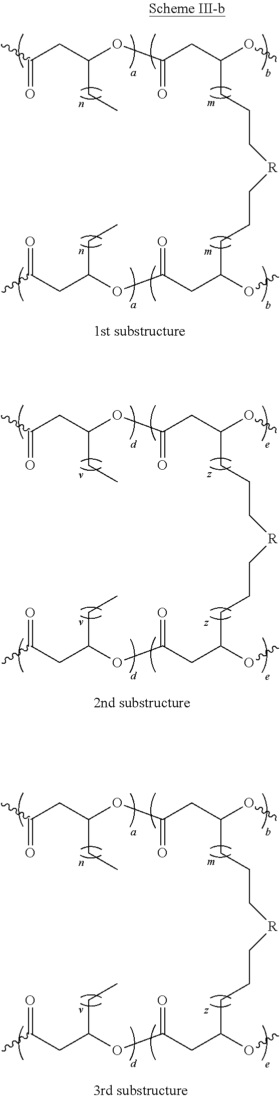

Referring to Scheme III, the first substructure results from crosslinking two of a first PHA polymer having the same chemical structure as defined by a and b, the length of saturated repeat unit and reacted unsaturated repeat unit, respectively, and n and m, the number of —CH₂— groups present in each of the sidechains for the saturated repeat unit and reacted unsaturated repeat unit, respectively. The second substructure results from crosslinking two of a second PHA polymer having the same chemical structure as defined by d and e, the length of saturated repeat unit and reacted unsaturated repeat unit, respectively, and v and z, the number of —CH₂— groups present in each of the sidechains for the saturated repeat unit and reacted unsaturated repeat unit, respectively. In some embodiments of the present disclosure, the first substructure and the second substructure are different in that at least one of a, b, m, and/or n defining the first PHA polymer is different from at least one of d, c, v, and/or z defining the second PHA polymer. The third substructure results from the crosslinking of one of the first PHA polymer and one of the second PHA polymer. Referring again to Scheme III-b, 500≤a≤1500 or 800≤a≤1000 (saturated repeat unit), 10≤b≤500 or 50≤b≤250 (unsaturated repeat unit), 0≤m≤20 (saturated repeat unit), and 0≤n≤20 (unsaturated repeat unit); and 1000≤d≤3200 or 1200≤d≤3000 (saturated repeat unit), 10≤c≤200 or 50≤e≤150 (unsaturated repeat unit), 0≤v≤20 (saturated repeat unit), and 0≤z≤20 (unsaturated repeat unit). In addition, each polymer chain illustrated in each of the substructures illustrated in Scheme III may contain repeat unit having unreacted unsaturated sidechains.

In some embodiments of the present disclosure, a polymer network, i.e., a resin, such as a thermoset, as described above, may be characterized by a glass transition temperature between −100° C. and 0° C., or between −50° C. and −15° C. In some embodiments of the present disclosure, a polymer and/or network, e.g., a thermoset, as described above, may be characterized by a melting point between 0° C. and 160° C., or between 40° C. and 60° C. In some embodiments of the present disclosure, a polymer and/or network, e.g., a thermoset, as described above, may be characterized by a Young's modulus between 0.01 MPa and 10.0 MPa, or between 0.5 MPa and 1.0 MPa. In some embodiments of the present disclosure, a polymer and/or network, e.g., a thermoset, as described above, may be characterized by a storage modulus between 1 MPa and 5,000 MPa, or between 10 MPa and 1,000 MPa.

In some embodiments of the present disclosure, a polymer and/or network, e.g., a thermoset, as described above, may be characterized by an ultimate tensile strength between 0.001 MPa and 10.0 MPa, or between 0.01 MPa and 2.0 MPa. In some embodiments of the present disclosure, a polymer and/or network, e.g., a thermoset, as described above, may be characterized by an ultimate tensile strain (elongation) between 10% and 5,000%, or between 100% and 2,000%. In some embodiments of the present disclosure, a polymer and/or network, e.g., a thermoset, as described above, may be characterized by an elastic recovery of at least 5%, or of at least 75%.

Linear PHA production: PHAs were produced by genetically engineered bacteria. Strain engineering and gradient feedings were performed in shake flasks to produce the desired copolymer compositions in respectable yields. Pseudomonas putida KT2440 is a native producer of mcl-PHAs by the PHA synthase with substrate specificity to mcl-(R)-3-hydroxyacyl CoAs (3-HAs). The precursor 3-HAs can be synthesized using either the fatty acid biosynthesis pathway or the β-oxidation pathway with altered carbon chain length ranging from C₆ to C₁₄, which leads to uncontrollable carbon chain length and repeat unit ratios, saturated versus unsaturated repeat units, in the resulting mcl-PHA at the detriment of consistent material properties. The metabolic engineering strategy used herein was aimed at producing PHA copolymers that consisted of both saturated and unsaturated units with predictable repeat unit ratios.

### Experimental Results: PHDU and Crosslinked PHDU

PHDU was selected for elastomer development due to its desirable thermal properties, e.g., low T_{g} (ca. −50° C.), while its semicrystalline nature rendered it easy to handle compared to other materials, such as poly-(R)-(3-hydroxyoctanoate-co-3-hydroxyundecanoate (PHOU), which is tacky and viscous. Additionally, the similar sidechain length of saturated repeat units, D, and unsaturated units, U, units reduce the sidechain heterogeneity of the PHA copolymer synthesized by the bacterium. The semicrystalline nature also presented an interesting structure-property relationship space to explore regarding the effects of crosslinking on morphology. For example, it was hypothesized that a light crosslink density (˜5 mol %, e.g., referring to Structure I, U≈0.05 and D=1−U≈0.95), via quantitative alkene crosslinking, would be optimal to maintain ductile elastomer properties while a higher % U, PHDU-22 (e.g., PHDU with U≈0.22, molar fraction, and D=1−U≈0.88), was produced as a control for higher crosslink density.

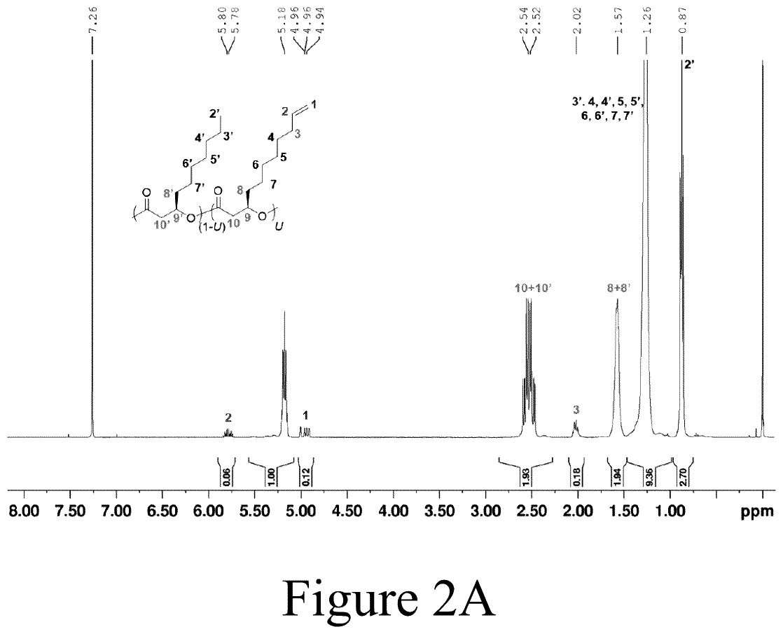

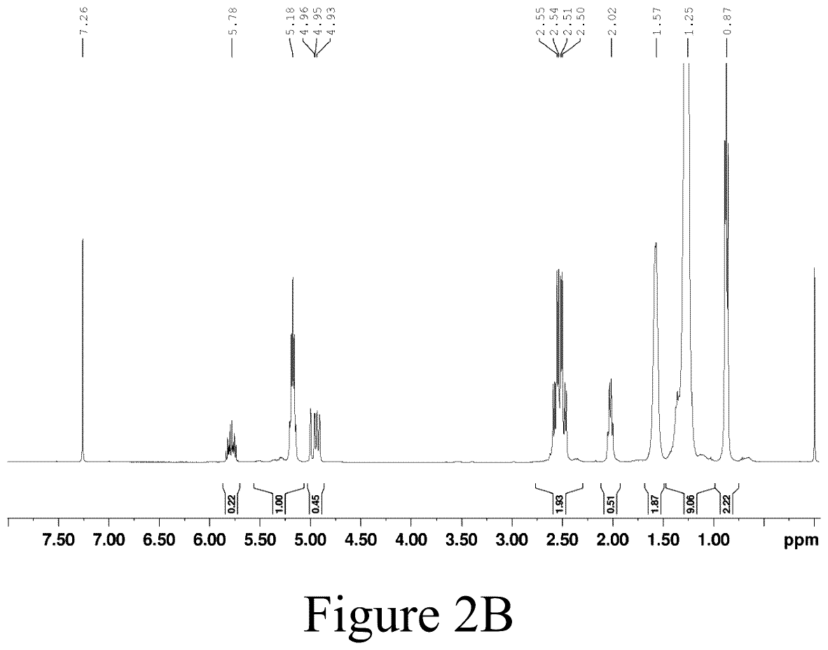

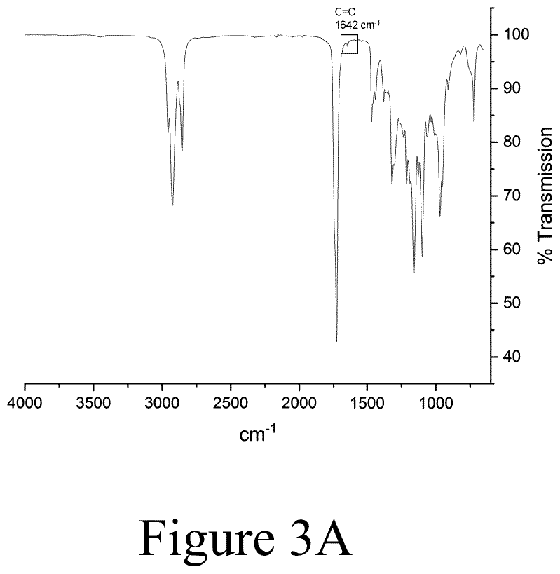

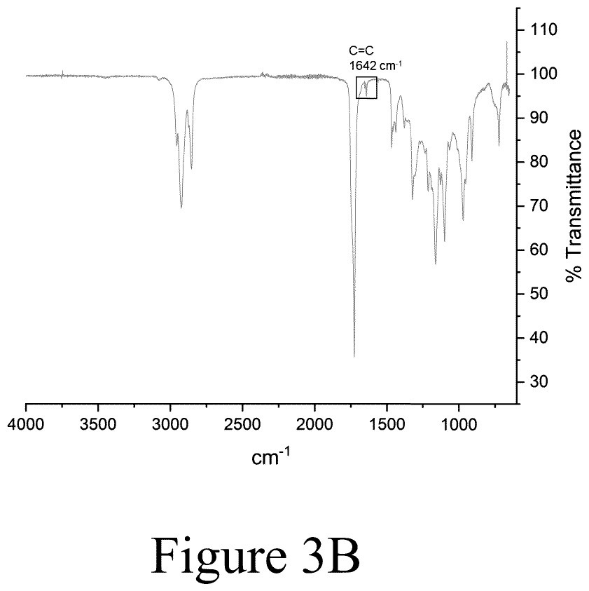

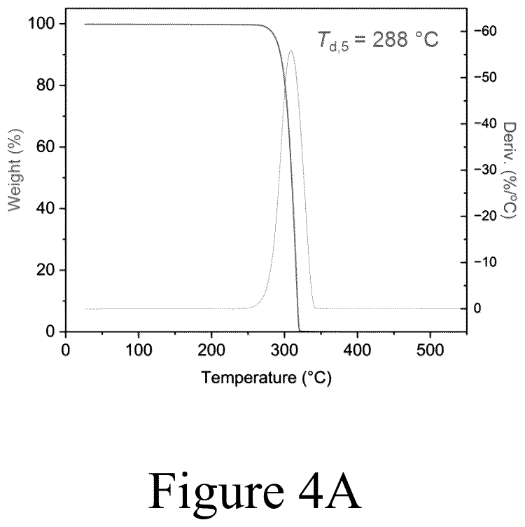

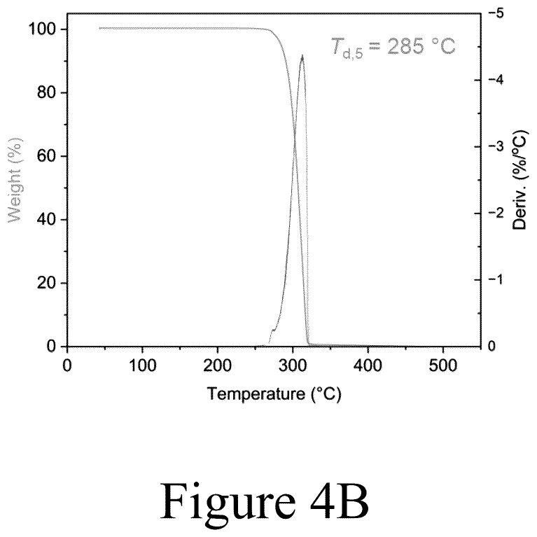

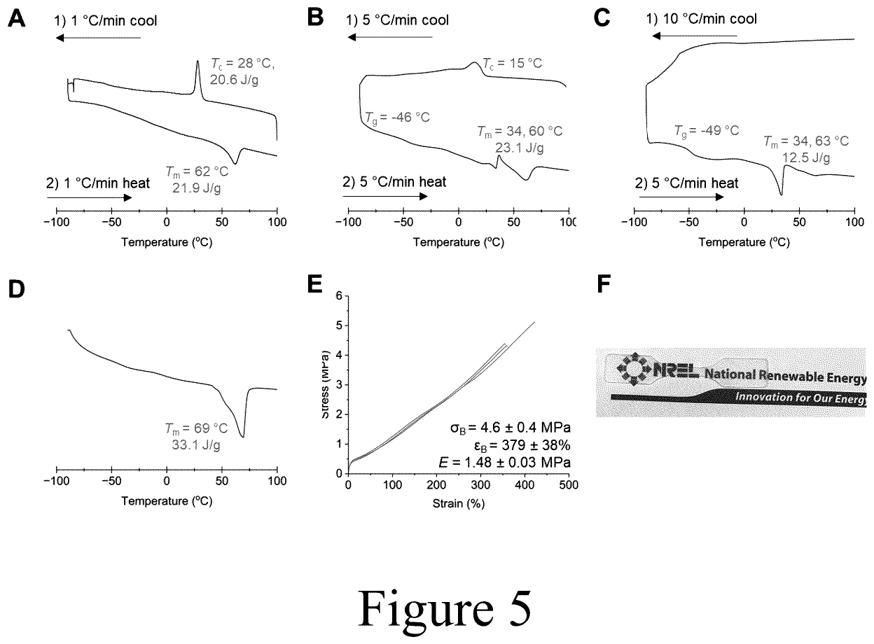

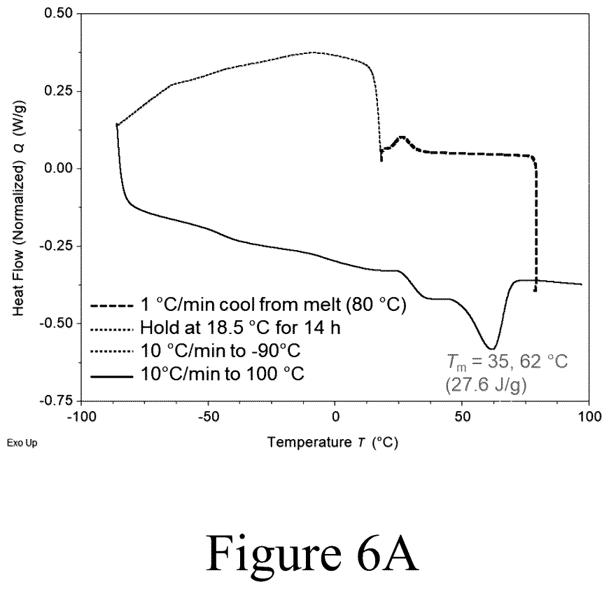

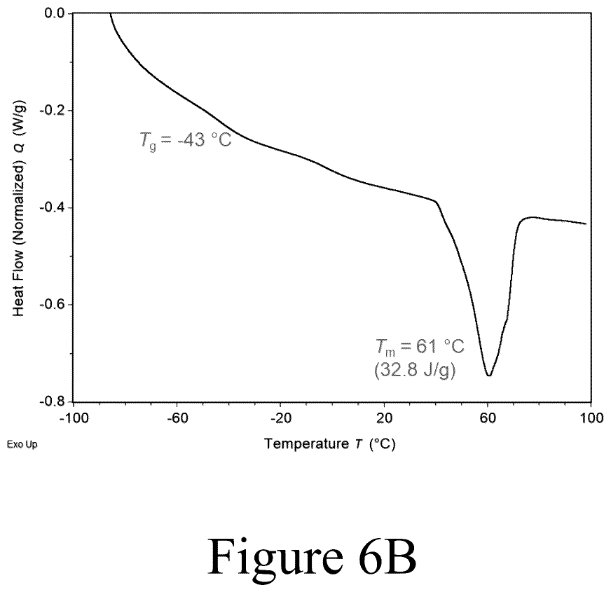

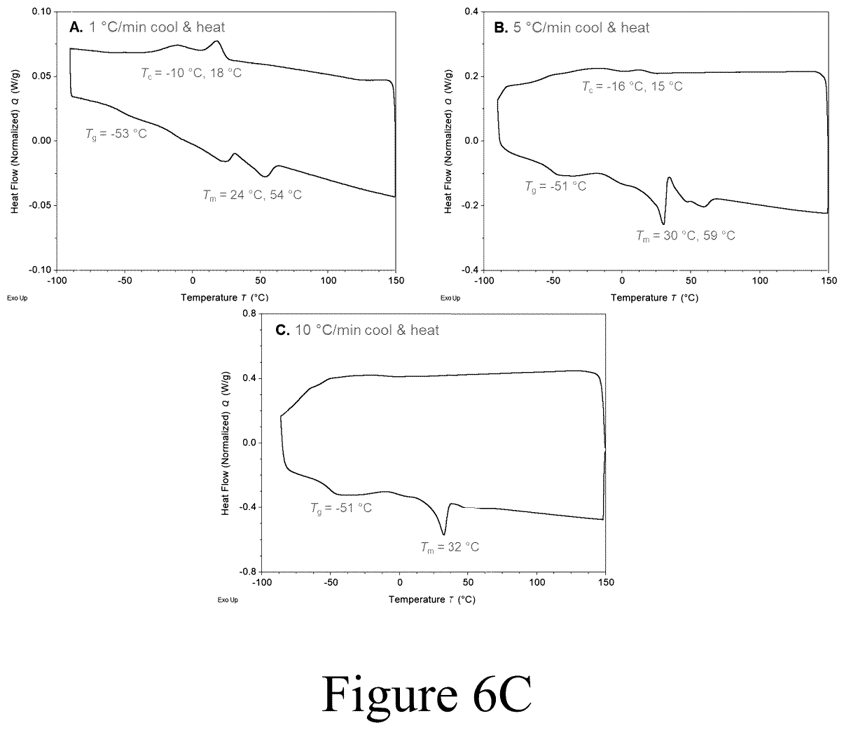

Linear PHDS base properties: Thorough characterization of linear PHDU properties was conducted to understand the effect of BE-crosslinking on thermal, mechanical, and rheological properties. PHDU-6 and PHDU-22 were subjected to analysis by NMR (see FIGS. 2A and 2B), Fourier-transform infrared spectroscopy (FTIR, sec FIGS. 3A and 3B), gel permeation chromatography (GPC, see Table 1A), thermogravimetric analysis (TGA, see FIGS. 4A and 4B), differential scanning calorimetry (DSC, sec Panels A-D of FIG. 5 and FIGS. 6A-6C), and tensile testing (Panel E of FIG. 5). Thermal and molecular weight properties are summarized in Table 1. Linear polymers were also characterized by dynamic mechanical analysis (DMA) and rheology; these results are presented below in direct comparison to the crosslinked products. Tensile analysis of compression-molded samples was performed using a saturated analog without alkenes (PHDUₛₐₜ) because heated compression molding of PHDU-6 led to brittle and insoluble material. Evidence of alkene side reactions was not evident by DSC and TGA tests. The onset degradation temperatures (T_{d,5}) of 285-288° C., are in agreement with the thermal degradation behavior of a similar mcl-usPHA.

TABLE 1
GPC and thermal analysis for linear PHDU samples

| | Mₙ | | T_{g} ^{c} | Tₘ | T_{d, 5} | a | b |
|---|---|---|---|---|---|---|---|
| Sample | [kDa]^{a} | Ð ^{b} | [° C.] | [° C.] ^{c} | [° C.] ^{d} | [# sat. units] | [# unsat. units] |
| PHDU-6 | 172 | 1.60 | −46 | 34, 60 | 288 | 940 | 60 |
| PHDU-22 | 186 | 1.55 | −51 | 30, 59 | 285 | 833 | 235 |
| PHDUₛₐₜ | 165 | 1.76 | −46 | 31, 60 | 283 | NA | NA |

^{a}Determined by GPC in CHCl₃ at 40° C. with 18-angle light scattering and RI detectors;
^{b} Molecular weight dispersity,
Ð = M_{w}/Mₙ;
^{c} Determined by DSC on the second heating cycle at 5° C./min heating and cooling rates;
^{d} Determined by TGA (20° C./min) under N₂ flow. a and b are calculated values based on Mₙ and U.

Owing to the semicrystalline nature of PHDU, the effect of DSC conditions and sample preparation on crystallization behavior was studied. Overall, PHDU-6 shows consistent behavior with that of the homopolymer having only saturated repeat units of poly-R-3-hydroxydecanoate (P3HD), which forms two crystalline phases. Phase I reflects crystallization of only the sidechains, with a lower Tₘ, and phase II comprises crystallized sidechains and backbone (higher Tₘ). One or both phases are evident in the DSC curves illustrated in Panels A-D of FIG. 5. Slower cooling and heating rates (1 and 5° C./min, Panels A and B of FIG. 5) led to a higher Tₘ value ˜60° C. and higher crystallinity (as quantified by the enthalpy of fusion, ΔH_{f}), reflecting phase II structure. After 10° C./min cooling and heating (see Panel C of FIG. 5), the lower Tₘ at 34° C. for phase I dominates. The cold crystallization behavior observed at 5° C./min shows the melting of phase I crystallites followed immediately by crystallization and melting of phase II. These behaviors align with slower crystallization and limited mobility of the rigid backbone and higher mobility/faster crystallization of the sidechains. For P3HD, 54 days were required for full conversion from amorphous to phase II during storage at 4° C. To maximize crystallinity of PHDU-6, an isothermal hold at the T_{c} (˜18° C.) for 14 hours resulted in ΔH_{f}=27.6 J/g and unresolved Tₘ peaks at 35 and 62° C. (see FIG. 6A). Bulk (‘as-precipitated’ from ethanol) PHDU-6 exhibits a Tₘ=61° C. (ΔH_{f}=32.8 J/g, FIG. 6B), and a film cast from CHCl₃ shows the highest crystallinity with Tₘ=69° C. and ΔH_{f}=33.1 J/g. These samples show a single Tₘ and represent a maximum crystallinity for PHDU-6 (see Panel D of FIG. 5) of up to 33 J/g.

PHDU-22 is a less crystalline material, suggesting that the heterogeneous sidechains, i.e., the variation in the chain-lengths of U and D, affect crystallization. Thermal studies revealed two Tₘ at 1 and 5° C./min rates (at ˜30 and ˜60° C.; see FIG. 6C, Panels A and B) with cold crystallization between the transitions, and solely the lower Tₘ is observed at 10° C./min (see FIG. 6C Panel C). Tensile analysis of colorless, compression-molded dog bone specimens of PHDUₛₐₜ showed adequate base properties from which to prepare networks having elastomeric properties: σ_{B} (strength at break)=4.6±0.4 MPa, ε_{B} (elongation at break)=379±38% (sec Panel E of FIG. 5), and no yield point.

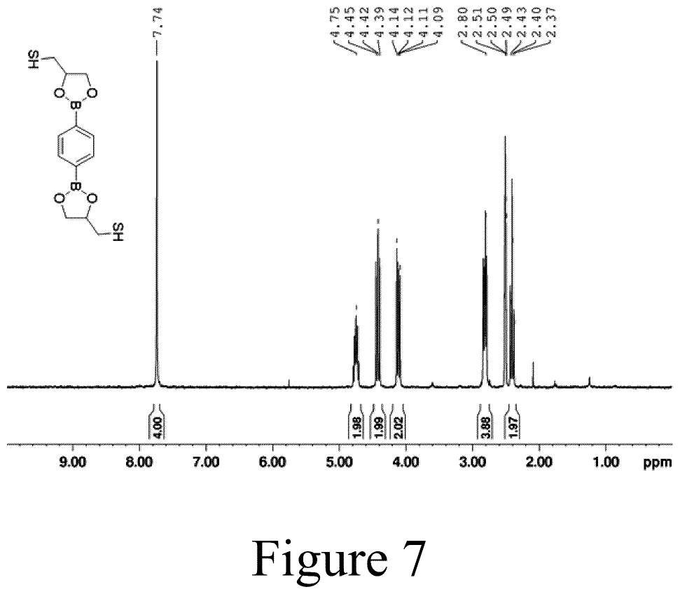

Crosslinking methodology, thermal, and structural characterization: Thiol-ene coupling reactions using Bis-BE-SH crosslinker (see Structure III above) were performed on a 100-mg scale using UV-initiated conditions at ambient temperature (see Scheme II above) (Bis-BE-SH ¹H NMR spectrum illustrated in FIG. 7). Crosslinking was performed in dilute, anhydrous THF solution (2.0 wt. % polymer) with excess SH:ene (2.5 eq. Bis-BE-SH:ene). Although permanently crosslinked thermosets (e.g., with static dithiol crosslinkers) could also be prepared using the solution method, mechanical samples could not be prepared in parallel to the thermosets (by compression molding) due to the lack of thermal processability.

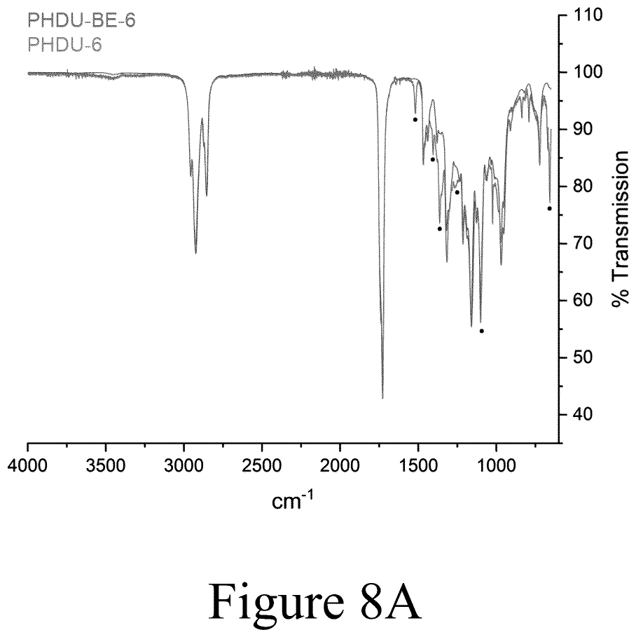

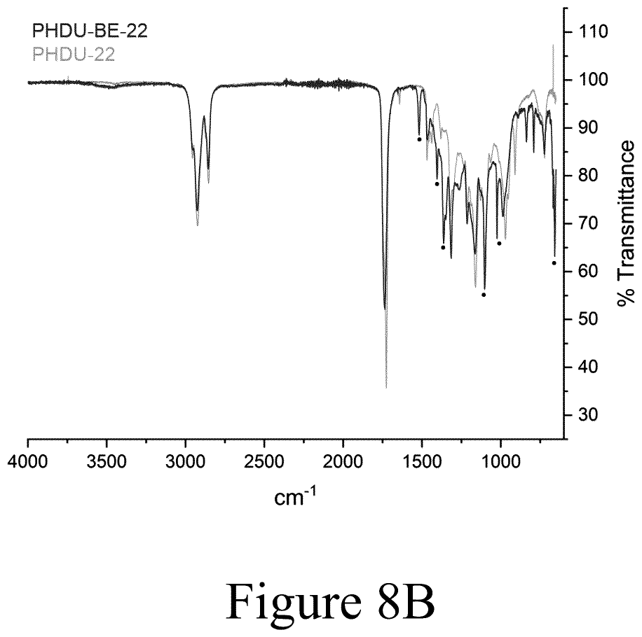

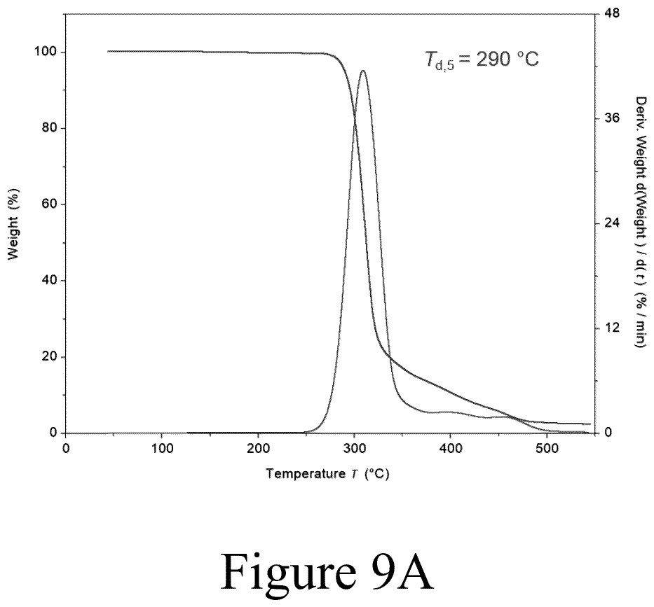

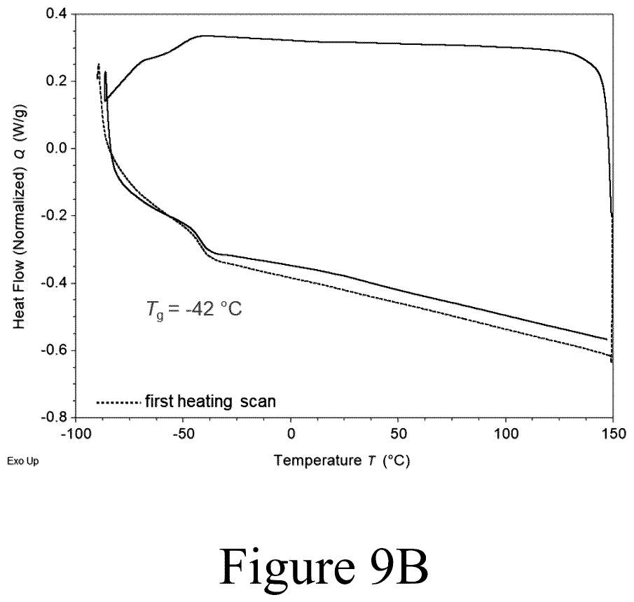

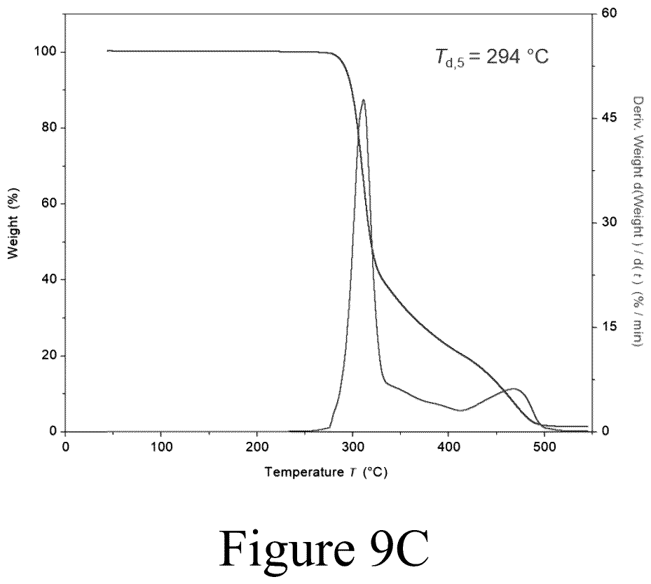

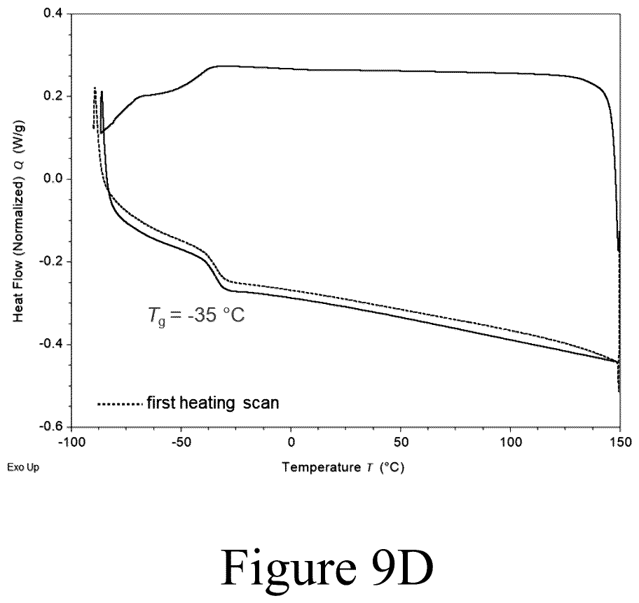

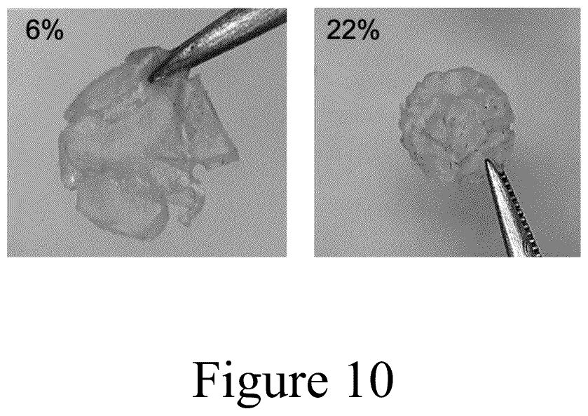

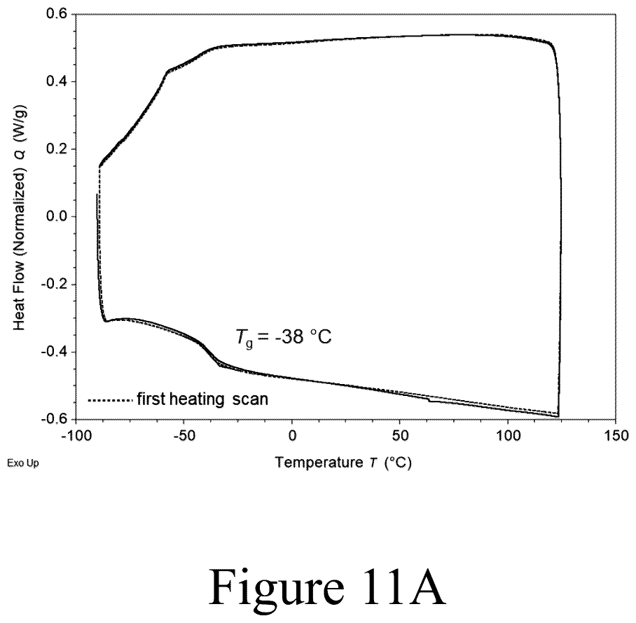

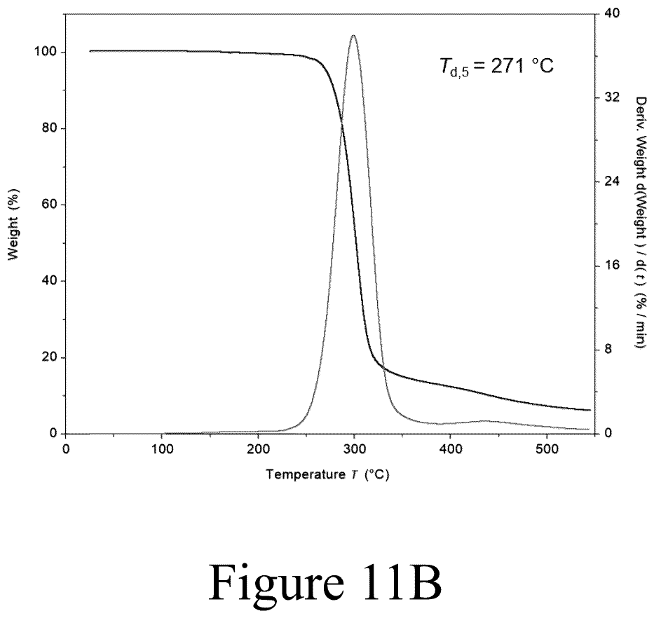

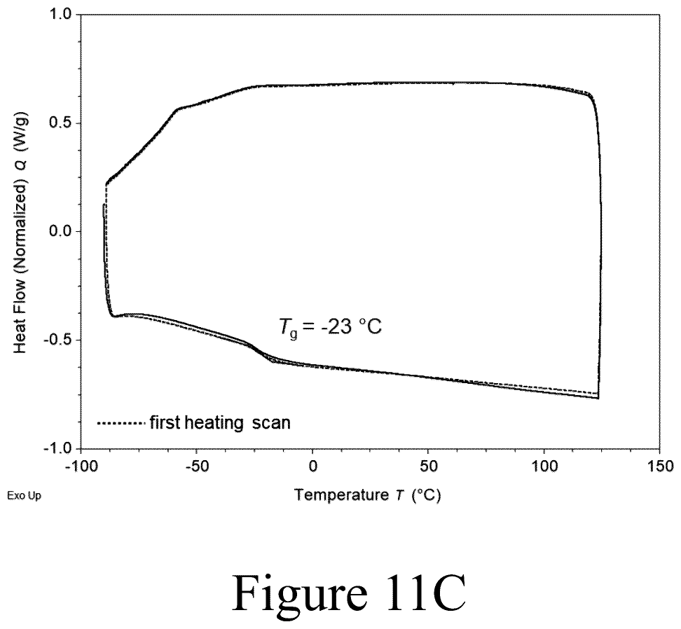

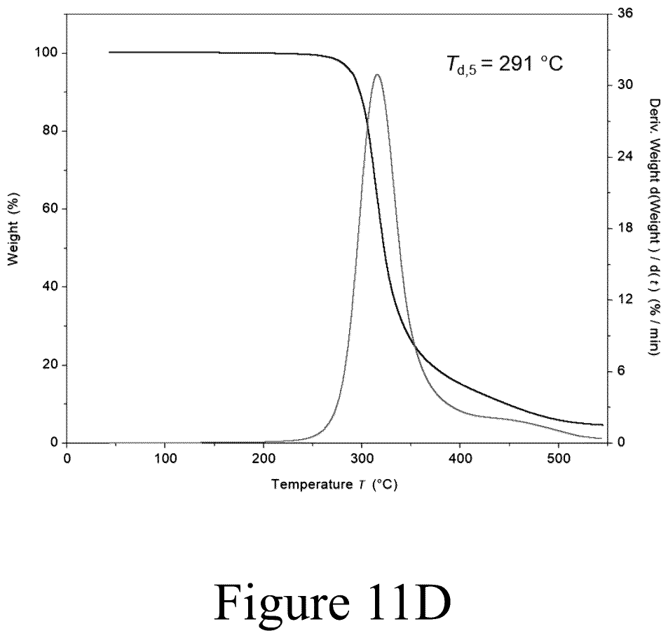

Crosslinking reactions yielded products (named PHDU-BE-X; X=original alkene mol %) that were insoluble, but swelled, in previously good solvents, e.g., solvents that could previously dissolve uncrosslinked PHAs, such as chloroform and/or tetrahydrofuran. Besides loss of solubility, crosslinking was evidenced by the formation of stable residue, by a >10° C. increase in T_{g}, the disappearance of the alkene FTIR signals at 1642 cm⁻¹, and appearance of BE-related FTIR signals (see FIGS. 8A and 8B). A control reaction with photo-initiator 2,2-dimethoxy-2-phenylacetophenone (DMDPA), PHDU-6, but no thiols resulted in a fully soluble product with intact alkenes by ¹H NMR. Reprocessability was confirmed by compression molding 8 mm-wide discs at a processing temperature between 110° C. and 125° C. for a period of time between 10 minutes and 15 minutes, which welded, i.e., joined, the fragments of bulk sample into a uniform, defect-free and colorless material. In contrast, PHDU crosslinked with pentacrythritol tetrakis (3-mercaptopropionate) (PHDU-TE-6 and PHDU-TE-22, TE=tetra-ester; DSC, TGA illustrated in FIGS. 9A-D) did not undergo complete welding, even with zinc catalyst and up to 21 hours of compression molding at 160° C.(photo: see FIG. 10). In this all-ester network, the nucleophilic alcohol end groups (or pendent thiols) were likely too dilute and/or immobile to participate in effective transesterification for healing. Likewise, crosslinking PHDU-6 and PHDU-22 with 4,4′-Bis(mercaptomethyl)biphenyl (BPh) yielded crosslinked products that were not thermally re-processable (see FIGS. 11A-D). Note: referring to Scheme I, THF refers to tetrahydrofuran and RT to room temperature.

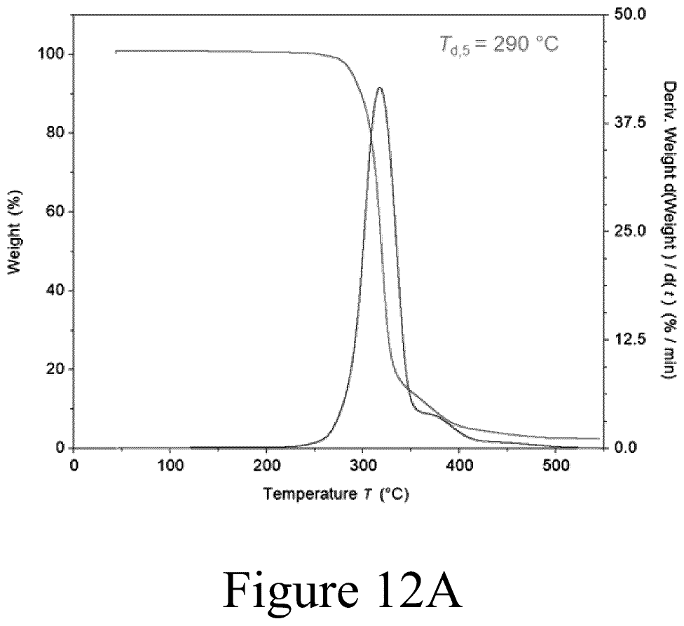

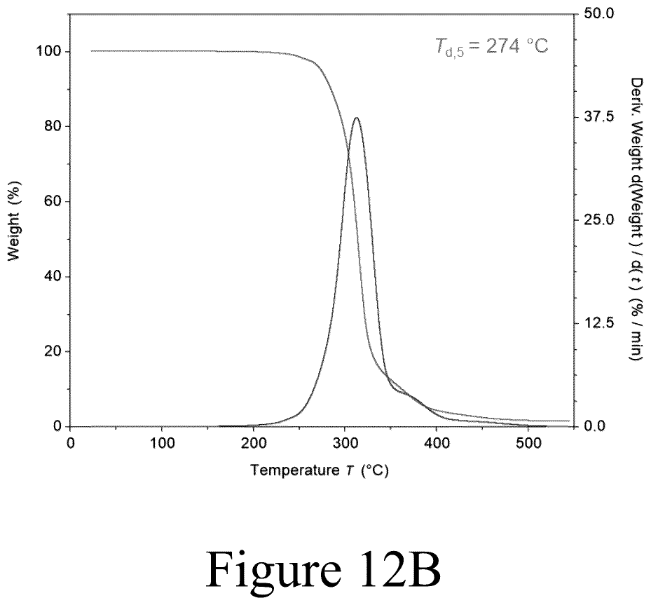

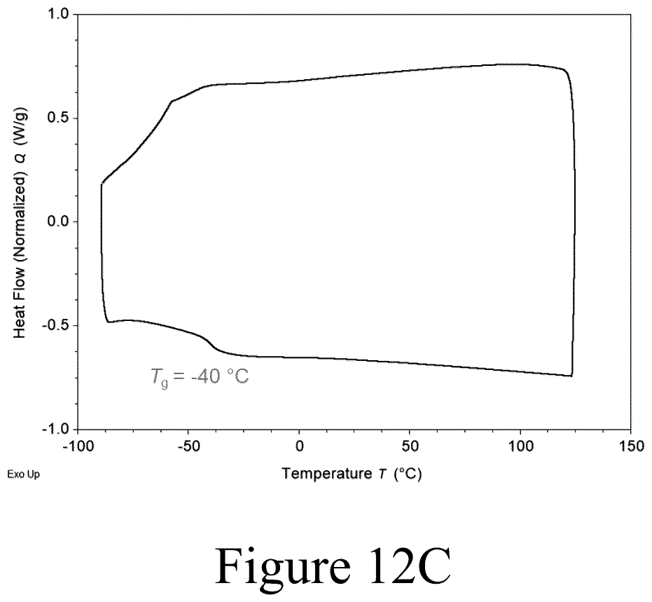

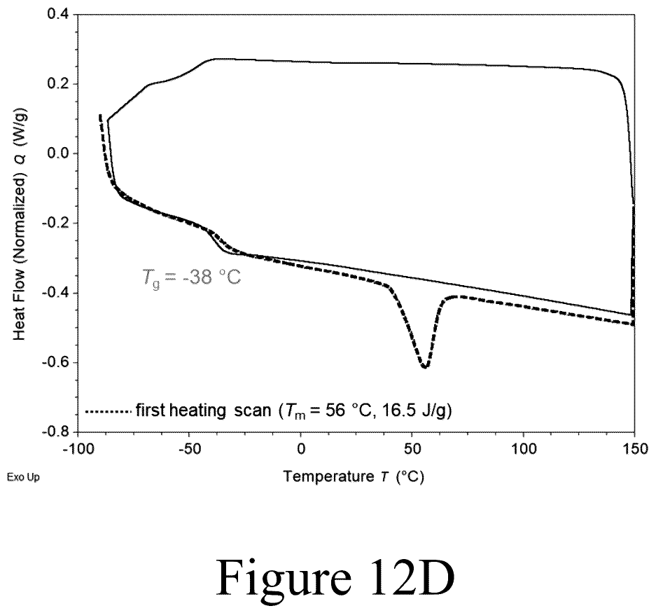

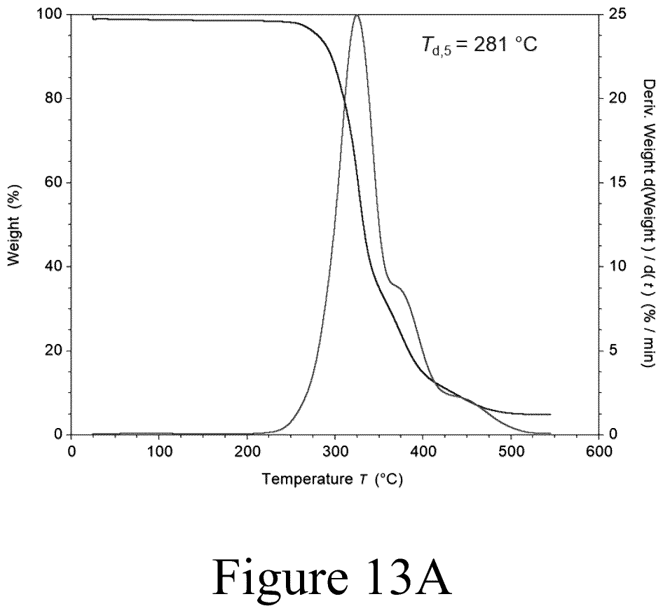

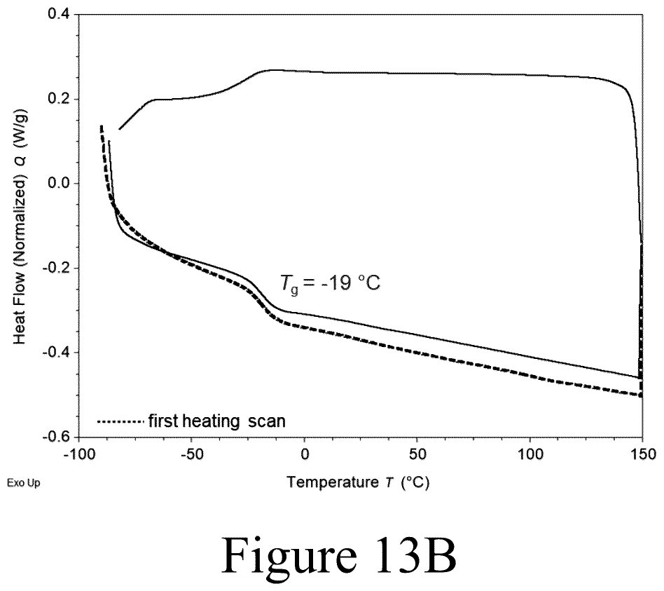

With this success, crosslinking of PHDU-6 was scaled up to 1.0- and 3.0-g batches (referred to herein as PHDU-BE-6-1g and PHDU-BE-6-3g, respectively). Materials made on all three scales showed agreement of thermal properties (see FIGS. 12A-D). PHDU-BE-6-1g was used for CHN elemental analysis (see Table 2) and freshwater biodegradation; the 3.0-g batch was used for tensile analysis over five reprocessing cycles, DMA, and rheological analysis. PHDU-BE-22 was scaled directly to 3.0 g (DSC, TGA illustrated in see FIGS. 13A-B), thereby confirming that crosslinking had occurred.

TABLE 2
CHN Elemental Analysis for PHDU samples
used for freshwater biodegradation test

| Sample | Mass | C % | H % | N % | O%/other (diff) |
|---|---|---|---|---|---|
| PHDU-BE-6 | 0.1023 | 68.1 | 9.4 | 0.0 | 22.5 |
| PHDU-BE-6 | 0.101 | 61.1 | 9.1 | 0.0 | 29.8 |
| | Average | 64.6 | 9.3 | 0.0 | 26.2 |
| | Stdev | 5.0 | 0.2 | 0.0 | 5.2 |
| | RSD | 7.7 | 1.8 | | 19.8 |
| PHDU-6 Linear | 0.0985 | 70.6 | 10.2 | 0.0 | 19.2 |
| PHDU-6 Linear | 0.1632 | 70.5 | 9.7 | 0.0 | 19.8 |
| | Average | 70.5 | 10.0 | 0.0 | 19.5 |
| | Stdev | 0.0 | 0.4 | 0.0 | 0.4 |
| | RSD | 0.1 | 3.6 | | 2.1 |

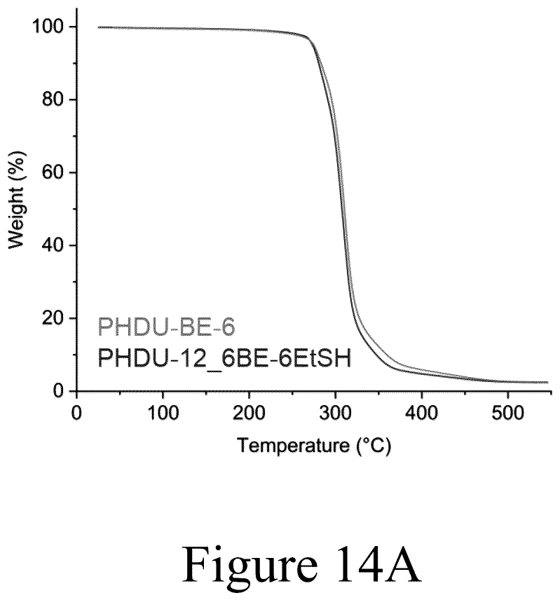

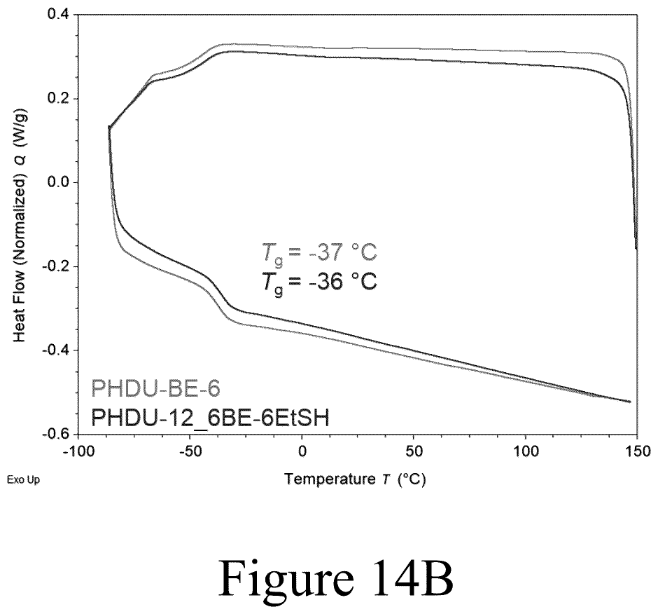

It was also demonstrated that the crosslinking density need not depend on the biologically determined % U. A PHDU-12 sample was crosslinked at approximately a 6 mol % crosslink density by reacting with a thiol mixture comprising half crosslinker Bis-BE-SH and half ‘end-capping’ reagent, ethanethiol (5 eq. SHₜₒₜₐₗ:ene) to consume the remaining thiols. Compared to a control in which PHDU-6 was quantitatively crosslinked, the approach with PHDU-12 resulted in products with matching thermal properties (see FIGS. 14A and 14B), but we pursued quantitative alkene crosslinking for simplicity.

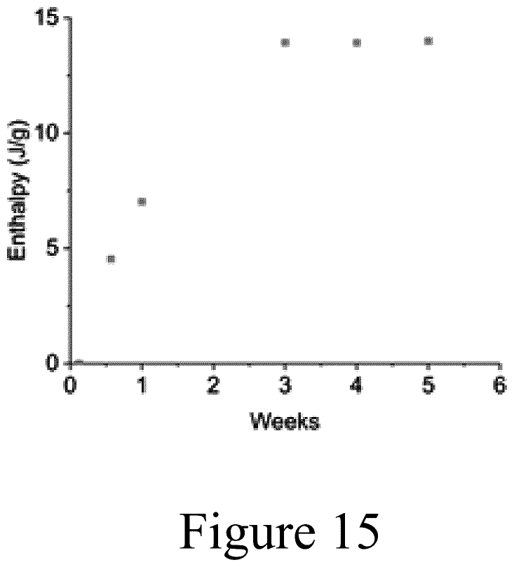

Sample PHDU-BE-6 that had been compression-molded (110° C., 15 min) and aged for 5 weeks (from 100-mg scale crosslinking) felt stiffer than the sample directly after processing. This sample showed ΔH_{f}=12.7 J/g, in contrast to the amorphous behavior shown in DSC scans at 10° C./min. A 5-week aging study was then performed on PHDU-BE-6 (see FIG. 15), which revealed that the material begins amorphous, crystallizes within one week, and plateaus after three weeks at ˜14 J/g. Slow cooling rates and isothermal holds in DSC experiments did not result in any crystallization: only time or antisolvent treating (using methanol) could induce crystallization of PHDU-BE-6. PHDU-BE-22% remained amorphous indefinitely after crosslinking.

Mechanical characterization of PHDU thermosets: PHDU-BE-6 was thermally (re)processed by cutting into pieces and compression molding in dog bone-shaped molds (ASTM type V, 0.8 mm thick) at 110° C. for ˜10 minutes, cooling slowly under pressure, and subjecting to a one-week aging period in air before DMA experiments and tensile testing. This aging period was chosen to allow crystallization to take place but avoid excessive waiting periods. After the aging period, the surface of PHDU-BE-6 was no longer tacky.

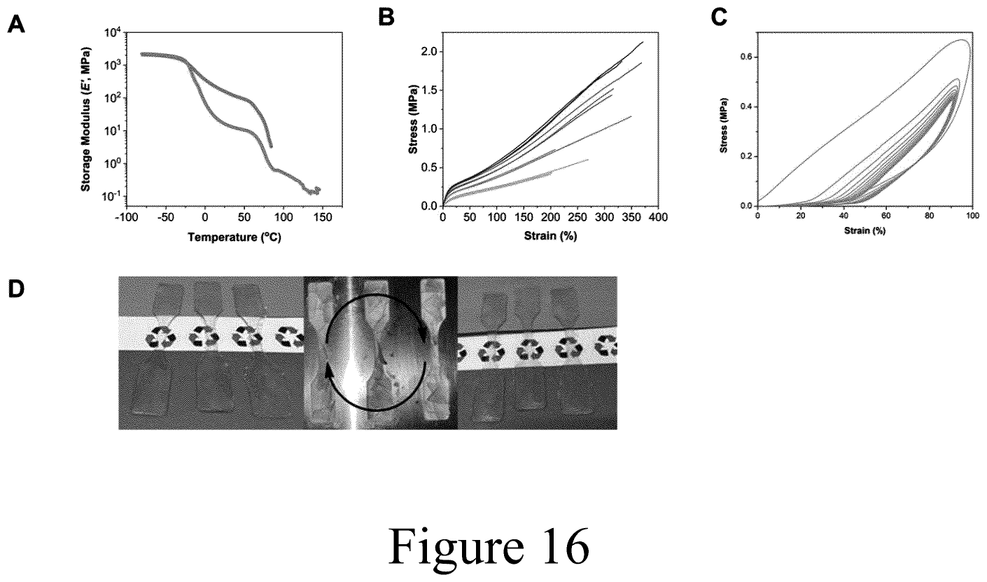

Thermomechanical profiles by DMA of the storage modulus (E′) versus temperature for PHDU-BE-6 thermoset relative to the linear PHA parent are illustrated in Panel A of FIG. 16. This test revealed a slightly increased storage modulus (2.2 GPa) at sub-T_{g} temperatures, and thereafter, the crosslinked product shows a lower storage modulus by one order of magnitude. Linear PHA PHDU-6 fails soon after surpassing the Tₘ, as is typical for thermoplastics. The crosslinked PHDU-BE-6 sample was also semicrystalline, thus the storage modulus is further reduced after surpassing the Tₘ, but the crosslinked material shows enhanced thermal stability up to 150° C., relying on the manifested crosslinked character.

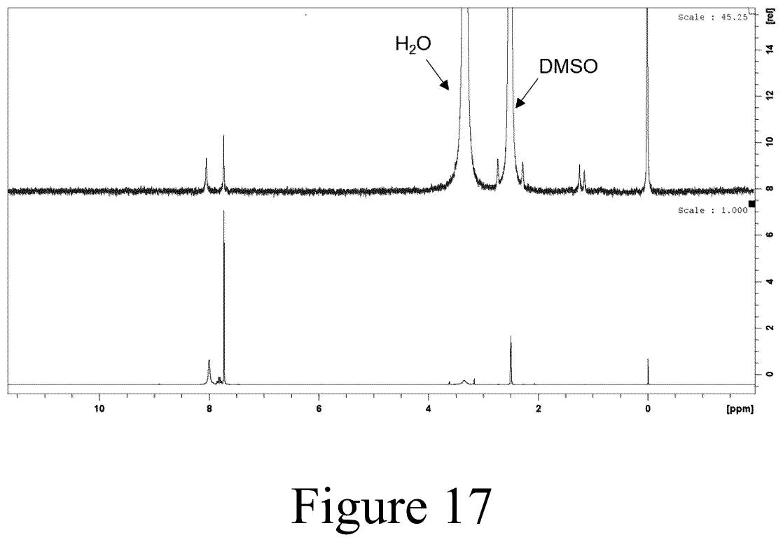

Tensile testing over four cycles of reprocessing (with one week of aging in-air between processing and testing) revealed a reduction in Young's modulus and tensile strength relative to linear PHDU PHA by about one order of magnitude (see Panel B of FIG. 16). There is also a clear shift towards higher σ_{B} and ε_{B}, but Young's modulus remained relatively constant over the cycles (see Table 3). Notably, reprocessing did not lead to discoloration of the cross-linked material (see Panel D of FIG. 16). The shift in tensile profile tends toward the original thermoplastic properties (i.e., of the linear, uncrosslinked PHAs) (see Panel B of FIG. 16 and Panel E of FIG. 5), as both the ultimate strength and elongation increase with each cycle. This points to a reduction in crosslink density throughout the analysis period, which would occur due to hydrolysis of the moisture-sensitive BE linkage. This was confirmed when a three-month-old film of PHDU-BE-6-1g, which had been stored in a LDPE bag, was found with a white substance on the surface. When swabbed with DMSO-d₆, the substance was identified as 1,4-benzene diboronic acid by ¹H NMR (see FIG. 17).

TABLE 3
Tabulated stress, strain, and Young's modulus values
of PHDU-BE-6 over 4 thermal processing cycles

| | ε_{B} (%) | σ_{B} (MPa) | E (MPa) |
|---|---|---|---|
| Cycle 1 | 222 ± 41 | 0.48 ± 0.10 | 0.55 ± 0.04 |
| Cycle 2 | 281 ± 71 | 0.95 ± 0.22 | 0.78 ± 0.29 |
| Cycle 3 | 333 ± 31 | 1.61 ± 0.22 | 0.60 ± 0.09 |
| Cycle 4 | 333 ± 37 | 1.90 ± 0.21 | 0.63 ± 0.02 |

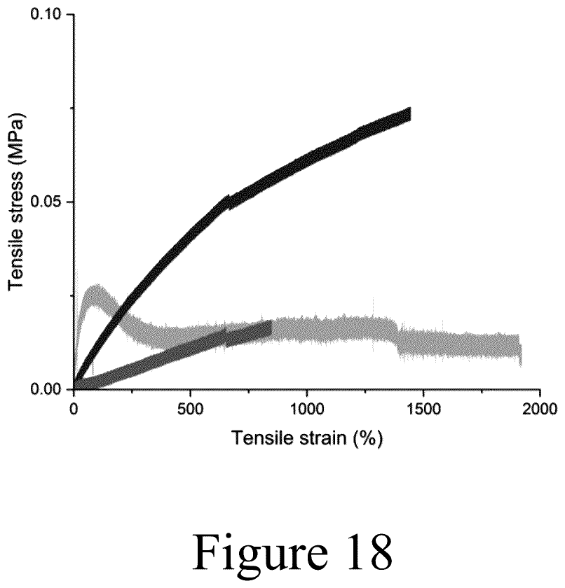

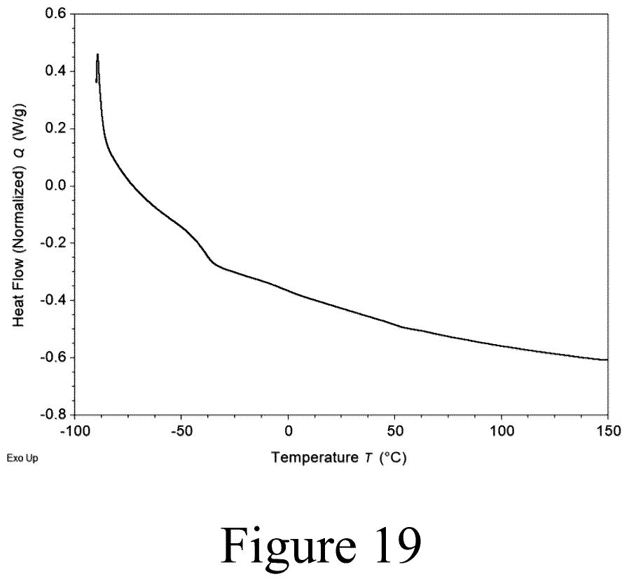

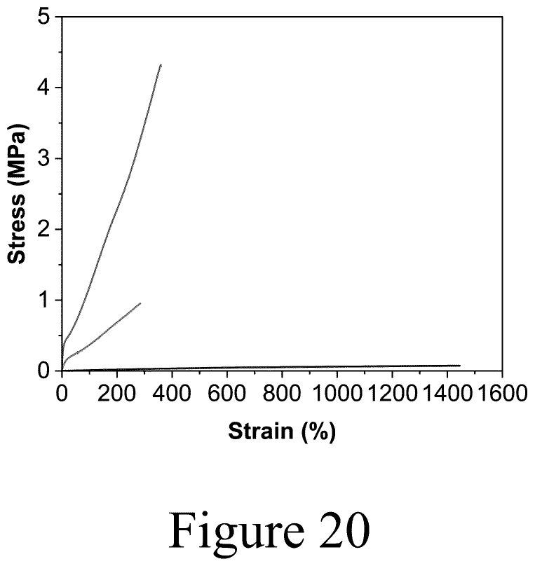

With this finding, a fifth cycle of processing was performed on the crosslinked PHDU-BE-6 dog bone specimens. A higher temperature was applied for a longer time (160° C., 30 min) to aid re-networking with water removal. Reprocessing was followed by aging with desiccant (CaCl₂) in two LDPE bags for one week to prevent re-introduction of water. The Teflon sheets used during compression molding were also left adhered to the specimens during this period. This treatment resulted in a strikingly different tensile profile with significantly higher elongations (up to 1800%) and lower strength (see FIG. 18). A DSC scan of the material after this tensile test showed essentially zero crystallinity (see FIG. 19). The tensile properties of semicrystalline and amorphous PHDU-BE-6 are mapped against the linear parent in FIG. 20. Emphasis is placed on the critical influence of boronic ester hydrolysis, which displaces (i.e., breaks or opens) crosslinks and encourages PHDU crystallization, altering material properties.

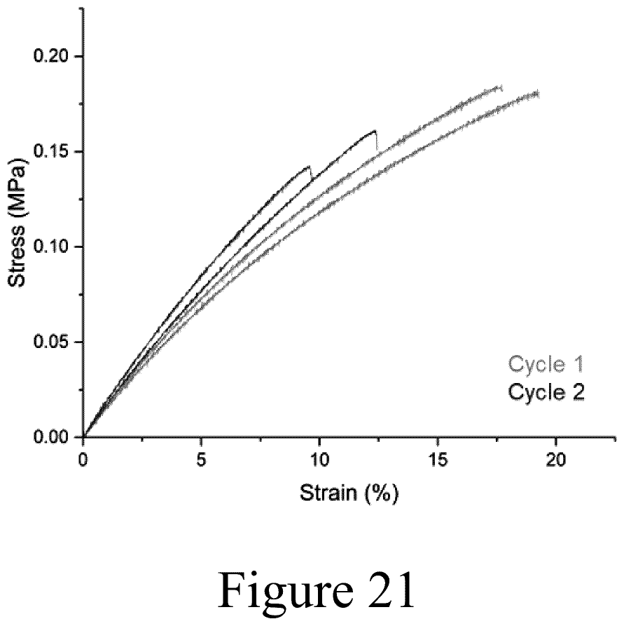

The PHDU-BE-6 thermoset exhibited elastic properties during cyclic tension deformation experiments, or hysteresis loops. As illustrated in Panel C of FIG. 16, the material (processed at 110° C. and aged one week) was strained to 100% elongation reversibly over 10 cycles, showing modest elastic recovery of 80% (˜25° C., 100%/min). The semicrystalline nature of this sample is thought to contribute to permanent strain. The PHDU-BE-22 thermoset showed poor film integrity and was not suitable for DMA sample preparation or testing. Two cycles of thermal processing were conducted on PHDU-BE-22 dog bone specimens for tensile testing (see FIG. 21). The higher crosslinking density in PHDU-BE-22 required a higher reprocessing temperature of 150° C. for complete welding during compression molding, and the material showed heavily reduced tensile properties, becoming a soft and brittle material (see FIG. 21, ε_{B}≈10-20% σ_{B}≈0.15 MPa). The Young's modulus (E) of the PHDU-BE-22 thermoset, ≈1.5 MPa, showed a 2.3× increase relative to the PHDU-BE-6 thermoset (E_{average}=0.64 MPa). The change in properties from a ˜6% to ˜22% crosslinking density demonstrates the strong dependence of mechanical properties on crosslink density, as is the case for most thermoset materials.

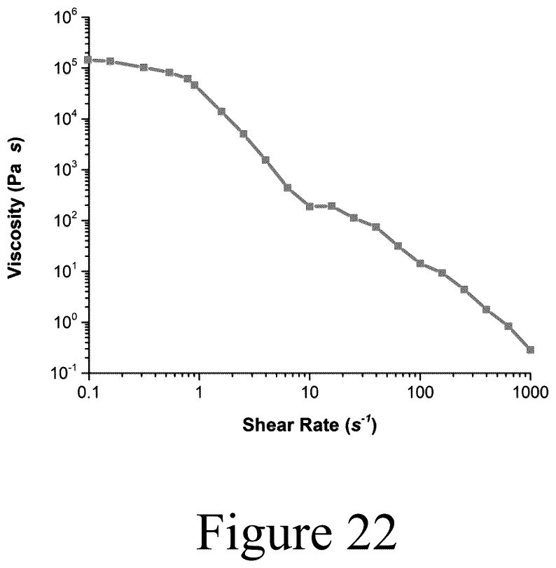

Rheological Properties: The viscosity of PHDU-BE-6 was measured at 175° C. as a function of shear rate (see FIG. 22), showing that low viscosities in the range of 1-10 Pa·s are achieved above a shear rate of 500 s⁻¹. This supports melt-processability for the BE-containing thermosets; however, permanent/static linkages would not show such low viscosities and would need to be cured into their final form, consistent with conventional thermoset preparation in industry.

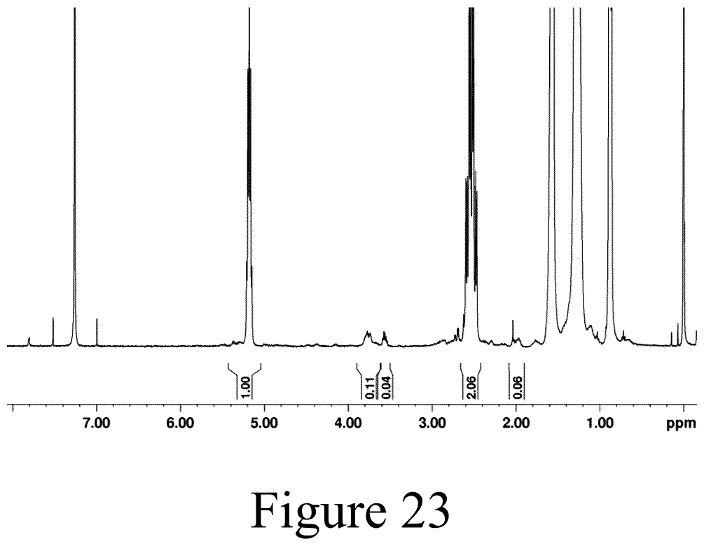

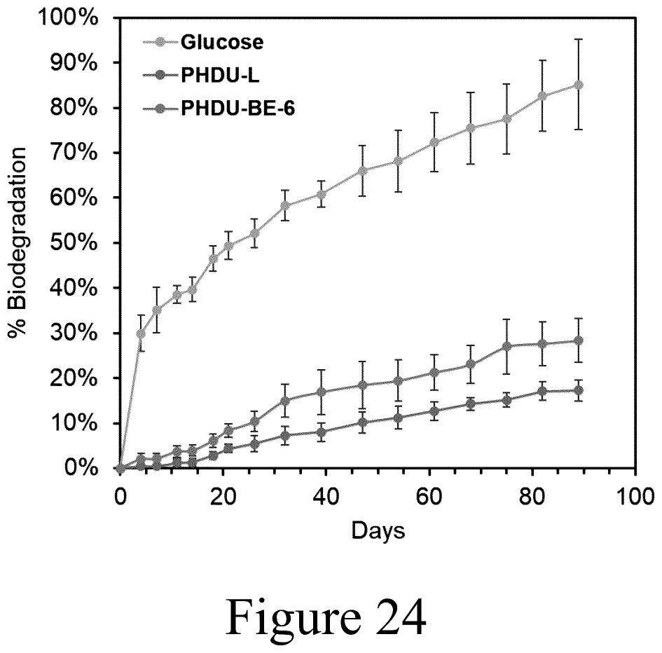

End-of-Life Studies: Finally, it was demonstrated that PHDU-BE thermoset materials have multiple end-of-life routes through thermal reprocessing (vide supra), chemical de-crosslinking (diolysis), and freshwater biodegradation. For de-crosslinking, the PHDU-BE-6 thermoset was combined with THF and 1,2-propanediol and the resultant linear, glycolated PHDU, which was soluble in CDCl₃ (¹H NMR: see FIG. 23), was recovered, thus confirming the conversion of the crosslinked material to a linear thermoplastic.

To demonstrate biodegradation, biodegradation of PHDU-BE-6 was conducted in parallel to PHDU-6 according to ISO 14851 method for freshwater environment over 89 days at ambient temperature. The aqueous test was activated with activated sludge from a wastewater treatment plant (Lemont, IL) and was conducted at ambient temperature with samples in film format. The results are shown in FIG. 14 relative to a glucose control. Interestingly, the crosslinked sample degraded at a higher rate than the linear parent during the degradation experiment, reaching 33% degradation relative to glucose versus 20% for the linear polymer (see Table 4). In the freshwater environment, PHDU-BE-6 is estimated to reach 90% biodegradation in 1.56 years with a first order kinetic model. Freshwater testing was selected owing to the small sample mass requirements and it is noted that biodegradation kinetics would be expected to differ for other environments (i.e., ambient soil or industrial compost).

TABLE 4
Results of freshwater biodegradation test after 89 days

| Sample | Biodegradation | Relative to glucose |
|---|---|---|
| Glucose | 85.15 ± 9.95% | 100% |
| PHDU-L | 17.26 ± 2.35% | 20.27% |
| PHDU-BE | 28.37 ± 4.83% | 33.32% |

For PHDU crosslinking methodology, solution-phase reactions were employed, as the equipment required for neat curing was not accessible, which requires good mixing of molten polymer, crosslinker, and radical initiator at a small scale. Here, the dynamic BE linkages enabled thermal processing into desired forms after synthesis. For vitrimeric materials with thermal processability, crosslinking could take place in a mechanically stirred and heated vessel and later processed into a desired form, akin to thermoplastics. A UV-assisted 3D printing method could also be developed for crosslinking mcl-usPHAs directly into final forms. If classical (static) thermosets from usPHAs are desired, processing into the final form is required, and could be performed by reactive injection molding or 3D printing.

The effect of crosslinking on mechanical properties is often an increase in moduli (E, E′) owing to reinforcements supplied by the network. For PHDU however, the effect is a decreasing one, creating a softer material because the crosslinks disrupt crystallization. This effect demonstrates that the mechanical properties of linear PHDU are imparted by the crystallinity and is further exemplified by comparison to amorphous mcl-PHAs that are tacky and viscous semi-solids. In either case, covalent crosslinking still provides reversible elasticity compared to thermoplastics with entanglement alone.

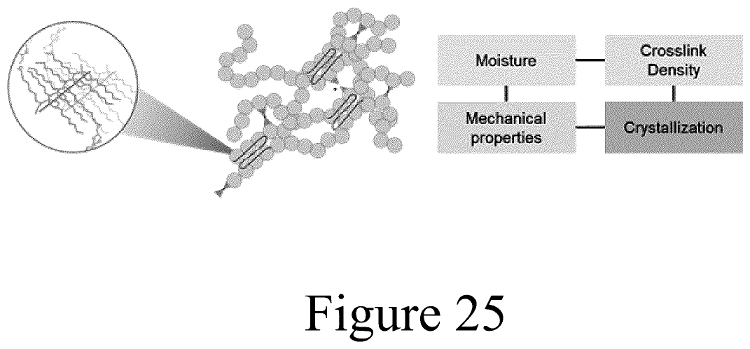

The thermomechanical properties of PHDU-BE materials demonstrate a strong dependence on morphology and crosslink density, both of which were found to be affected by the moisture-sensitivity of the BE linkage (see FIG. 25). When processed and stored in-air, PHDU-BE-6 crystallized slowly over the course of three weeks until a plateau was reached. In contrast, when stored in moisture-free conditions, the material remained amorphous. As BE linkages hydrolyze, the molecular weight between crosslinks increases, allowing higher degrees of freedom and larger domain sizes for crystallization. This indicates that there is a threshold crosslink density below 6 mol %, at which crystallization is allowed. It is here that the networks prepared from PHDU-BE-6 with non-BE crosslinkers, TE and BPh, showed zero or hardly detectable crystallinity on the first scan of the DSC, even though these samples were also treated with methanol (which induced crystallization of BE networks).

The plateau in crystallinity of ˜14 J/g for PHDU-BE-6 stored in-air likely reflects equilibrium with the local environment. Perhaps, the developed crystallinity also helps act as a barrier to further hydrolysis. Over the course of four processing cycles, the tensile properties continued to shift towards those of the original thermoplastic, indicating that processing at 110° C. was insufficient to re-network the material, which requires water removal. The amorphous samples were obtained on a fifth cycle of processing at 150° C., clearly demonstrating BE re-networking under these conditions. As expected, the amorphous samples exhibited more ideal elastic behavior than the semicrystalline samples, which exhibited irreversible strains when stretched repeatedly to 100% strain.

The dependency of material properties on crosslink density is exemplified by the poor quality of PHDU-BE-22 samples, which were weak and brittle. Too high a crosslinking density led to a reduction in network integrity that is imparted by both chain entanglements and covalent crosslinks.

Although the material properties were unexpectedly unstable, the observed range of properties provides a wide-angle lens view of the property space for crosslinked, soft PHAs of both semicrystalline and amorphous natures. These observations facilitate future material design targeting a desired and constant property set. Judicious selection of linear usPHA (amorphous or semicrystalline), crosslink density, and crosslink type (static or more stable dynamic crosslinker) would allow for more targeted material design. For example, beginning with less crystalline octanoate or hexanoate-based usPHAs would likely suppress crystallization even at low crosslinking densities, while a longer chain dodecanoate-based usPHA may tend towards crystallinity at low densities.

Interestingly, the thermomechanical properties of the PHDU-BE vitrimers studied here are similar to elastomeric BE vitrimers prepared from polybutadiene and polybutadiene-co-styrene. In one system beginning with high-vinyl, low Mₙ polybutadiene, the less dense networks prepared are comparable to semicrystalline PHDU-BE-6 regarding moduli and tensile properties (PHDU-BE-6, semicrystalline properties: E′ at 25° C.±17.2±0.6 MPa, E=0.64±0.10 MPa, σ_{B}=0.48-1.90 MPa ε_{B}=222-333%). For the least dense network reported, E′ at 25° C. is ca. 20 MPa, E is ca. 0.3 MPa, and σ_{B} and ε_{B} are 113% and 0.2 MPa, respectively. In a network beginning from commercial polybutadiene-co-styrene, tensile profiles to PHDU-BE-6 are also similar, achieving σ_{B} ca. 1.7 MPa and ε_{B} ca. 498% for the least dense network, but higher E ca. 1.86 MPa. Storage modulus was lower than PHDU-BE-6 at 25° C., ca. 1-2 MPa. These similarities suggest that semicrystalline, crosslinked PHDU could be a suitable replacement for polybutadiene in networks where biodegradability is desired. Note that the properties reported here are for the pure material, and commercial elastomers are soft composites which employ fillers to toughen the material and are highly formulated for specific applications. Effects of filler on mcl-PHA elastomers merit further investigation in a controlled fashion.

PHDU-BE networks also show comparable characteristics to other biodegradable and self-healing networks. Sustainable soft materials are desired in the fields of soft robotics and electronics as well as for biomedical devices. Broadly, for elastomers employed in soft robotics and electronics applications, there is an array of design parameters and challenges including: soft, tissue-like character (e.g., E=0.1-10 MPa), moderate and reversible elongations (>200%), convenient processability into unique shapes, self-healing ability, and circularity via bio-derived materials with biodegradability and/or recyclability. Materials from the platform of PHA-based vitrimers can meet each of these parameters and also solve the conflicting nature of processing and property requirements. That is, covalent crosslinks impart elasticity but prevent facile melt-processing by methods such as 3D printing, while vitrimers can be both elastic and melt-processable.^{[34]} In our examination of PHDU-BE-6 viscosity versus shear at 175° C., the viscosity becomes low enough for extrusion-based processing techniques of typical thermoplastics.

Self-healing and reprocessability is also enabled by the vitrimer linkages, which is ideal for repair in the field, prototyping, and recovery of other components. Current biodegradable and self-healing materials for these applications are often hydrogel-type materials; we note here that in the PHDU-based networks, no free solvent is necessary in the network composition. The PHA-based network also offers a biodegradation route with balanced stability and decomposition. Although BE hydrolysis contributed to dynamic material properties, it allowed for increased decomposition in freshwater relative to the linear polymer, and the free linker did not appear to affect the microbial community in the degradation experiment. Balancing material stability with degradation is a common challenge for degradable materials. Note that biodegradation kinetics will differ for other environments such as ambient soil or industrial compost, and that PHA-utilizing bacteria are most commonly found in soil. Another potential application is a removable adhesive, or ‘fugitive glue.’ The amorphous PHDU-BE-6 network was tacky and elastic, and showed good adhesion to plastic, metal, and glass surfaces while easily removed with no residue. As these adhesives are commonly used in mail advertising, biodegradability is advantageous for end-of-life considerations.

### Experimental Results: PHBU, Crosslinked PHBU, and Crosslinked PHBU-PHDU

The studies of relatively soft PHDU (sec Structure I) were followed by studies of relatively hard PHBU (see Structure IV), as well as polymers/resins synthesized using both PHDU and PHBU in the same composition, as illustrated in FIG. 1, resulting in structures like those illustrated in Scheme III above.

A strain of P. putida engineered to produce PHBU was used to obtain samples of PHBU to test. The resulting PHBU exhibited brittleness comparable with a homopolymer, poly(3-hydroxybutyrate) (P3HB). In response, PHBU (soft) and PHDU (hard) were blended (not reacted or crosslinked)at various ratios, achieving blended materials with ranges of hard, firm, and soft mechanical profiles under different blending ratios. However, a low mixing compatibility was observed between amorphous PHDU domains and highly crystalline PHBU domains in the blends. For that reason, crosslinking of a mixture of PHBU and PHDU was completed using dynamic Bis-BE-SH (see Structure III). Visualization of blend matrices by scanning electron microscopy (SEM) revealed the initial presence of micro-domains between incompatible usPHA blend components, reducing material viability, as well as the subsequent regression to homogenized and robust networks upon dynamic crosslinking compatibilization. The resulting compatibilized dynamic thermosets exhibited various rubber properties, highlights the potential in application. In addition, end-of-life experiments were completed on the resins/polymers, evaluating the reacted blends' abilities to biodegrade.

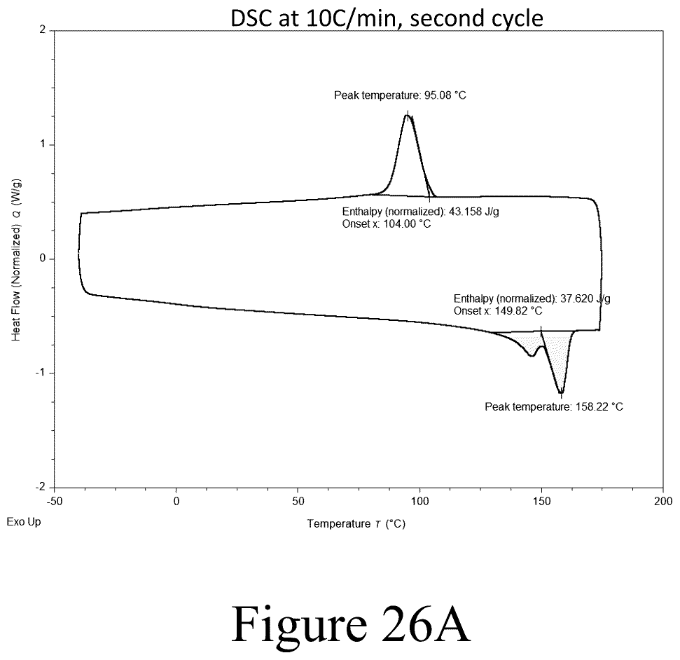

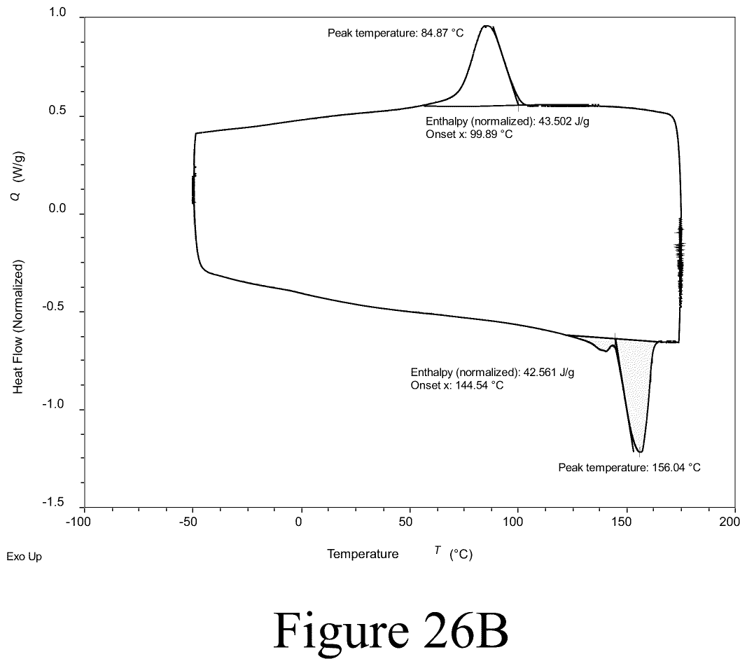

The recovered PHBU was reacted using a slightly different experimental method than that used for PHDU described above. A thermal radical initiator AIBN, Anisole solvent (anhydrous, degassed), and a reaction temperature of 80° C. were used because PHBU is not soluble in THF for the UV conditions used for PHDU. In a 20 mL vial equipped with a septum cap, 100 mg of PHBU-4 (U=4 mol %; 1.11 mmol polymer, 0.044 mmol alkene) was dissolved in 5 mL anisole (anhydrous, degassed) along with 68.8 mg Bis-BE-SH (0.22 mmol) inside an N₂-filled glovebox. A separate stock solution (10 mg/mL) of thermal radical initiator AIBN (azobisisobutyronitrile) was prepared with the degassed anisole in a septum sealed 4 mL vial. The solutions were removed from the glovebox and the reaction vial was interfaced to a N₂ flow on a Schlenk line and heated to 80° C. Once the PHBU dissolved, 100 uL of the AIBN stock solution was injected into the reaction solution and the reaction was stirred at 80° C. for 1 hour. The product was isolated by removing as much anisole as possible on the rotary evaporator, then washing the product with anhydrous methanol, and finally drying in the vacuum oven at 40° C. DSC results for linear PHBU-4 (U≈0.04 molar fraction) and crosslinked with itself PHBU-BE-4 (BE refers to crosslinked using Bis-BE-SH) are summarized in FIGS. 26A and 26B.

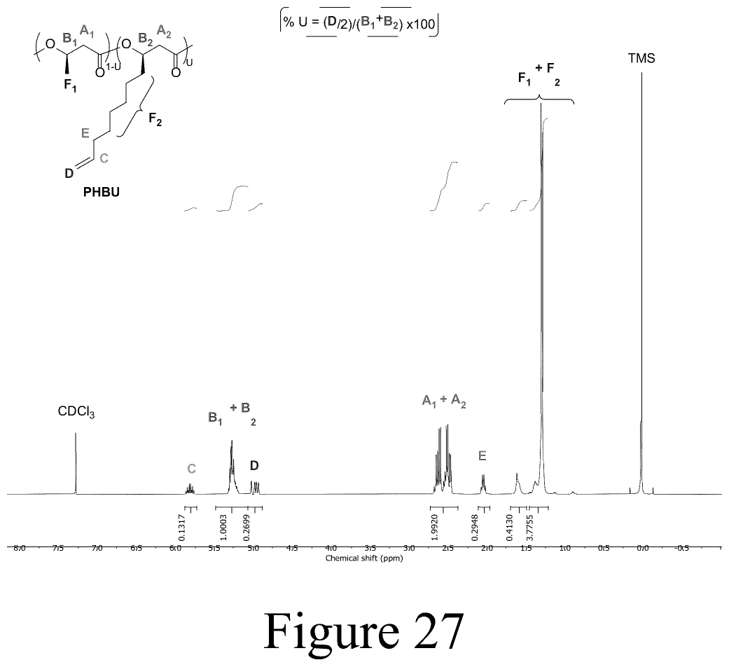

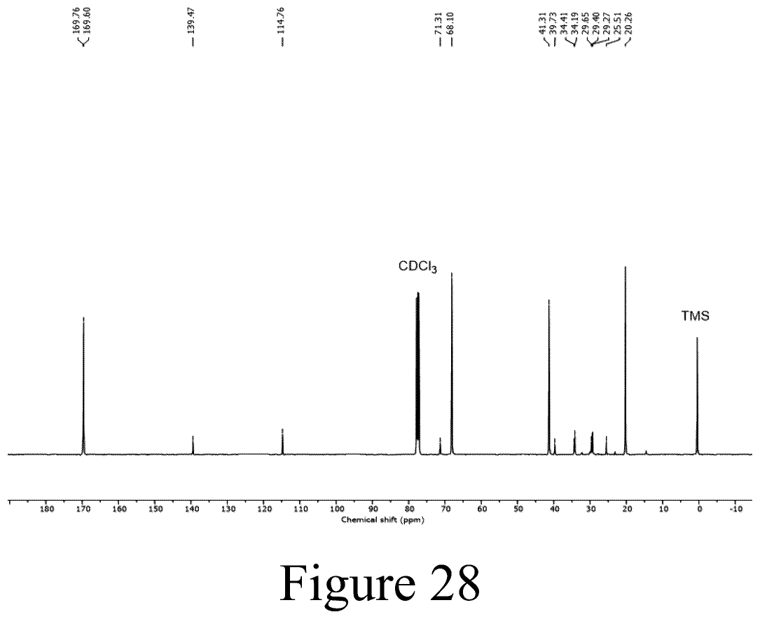

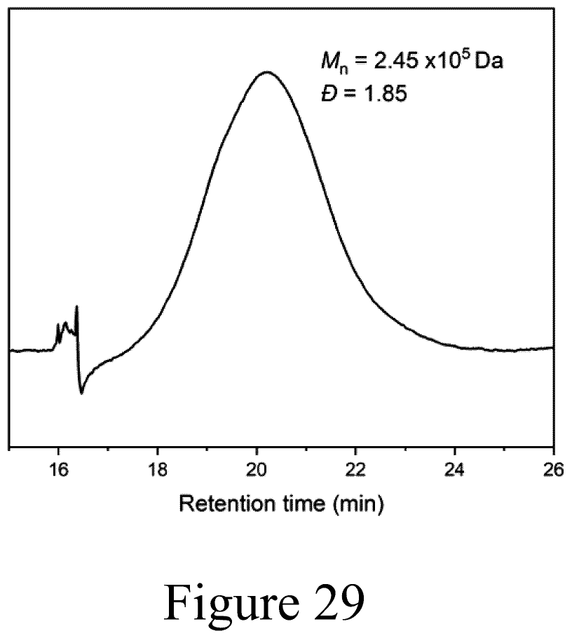

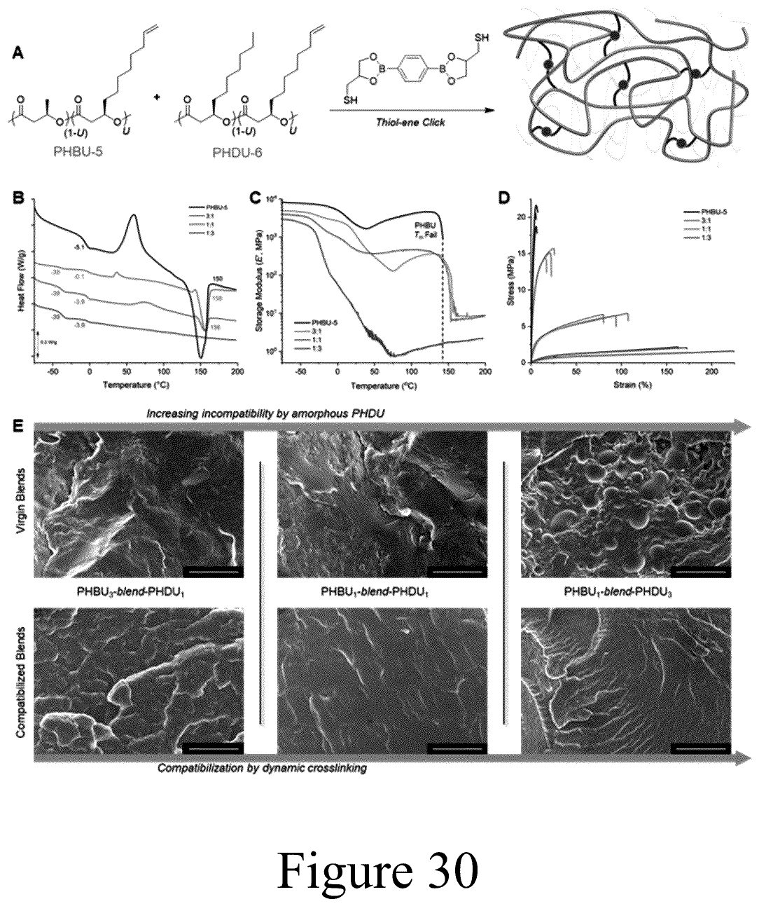

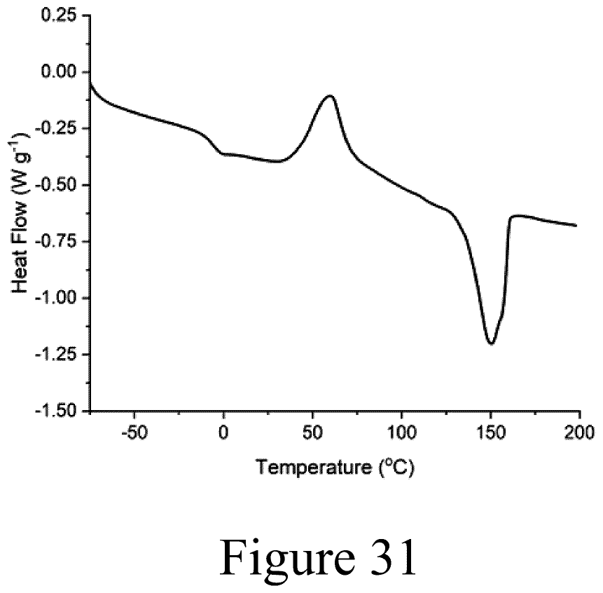

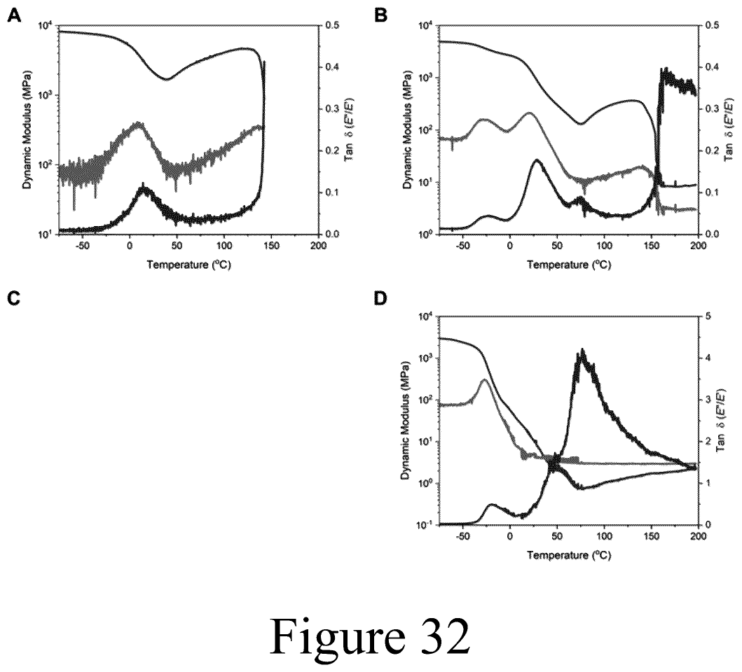

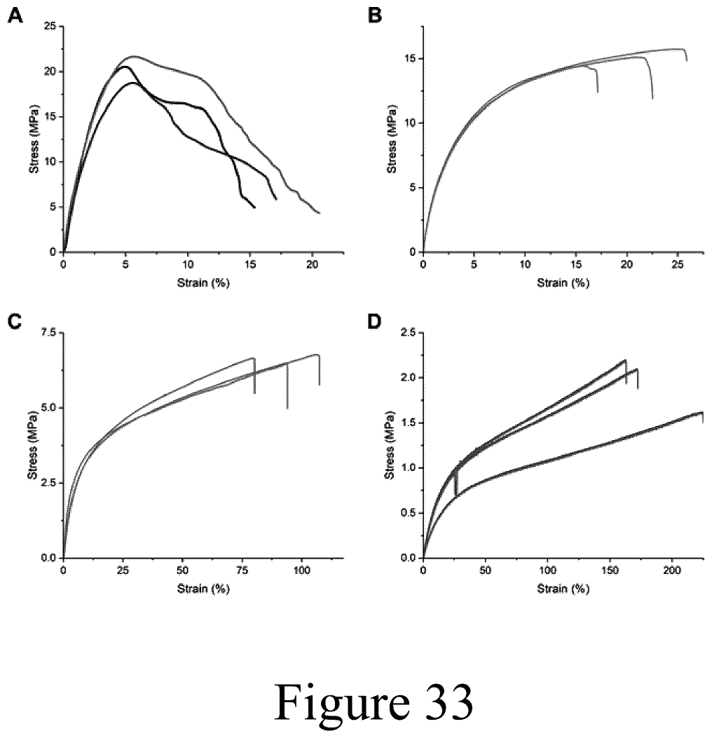

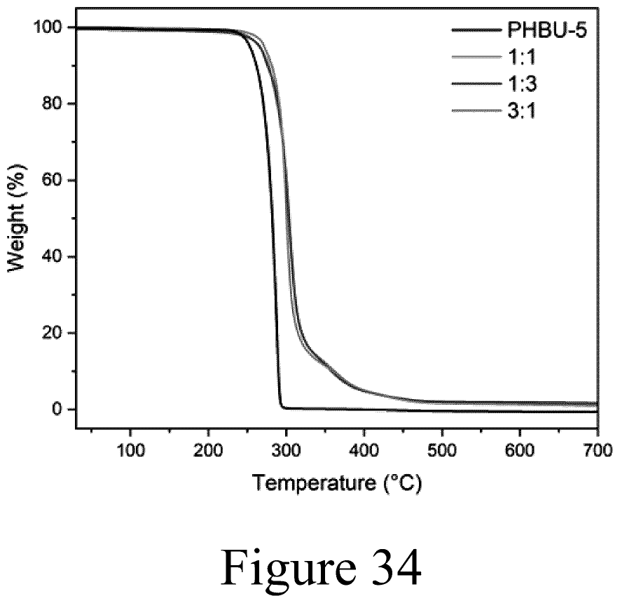

Recovered microbial scl-co-mcl PHBU was initially analyzed by ¹H (FIG. 27) showing U calculation) and ¹³C NMR (FIG. 28), gel permeation chromatography (GPC; CHCl₃) confirming high molecular weight (Mₙ=2.45×10⁵ kg mol⁻¹, Ð=1.85) product (see FIG. 29 and Table 5). PHBU-5 yielded similar qualities to that of the brittle homopolymer P3HB once brought to thin film stage. More specifically, PHBU-5 exhibited a modest Young's modulus (E=830 MPa) but poor ductility (ε_{B}=18%) (see Panel D of FIG. 30), owing to the high crystallinity reflected in the melting temperature (Tₘ) of 150° C. and enthalpy of fusion (ΔH_{f}) of 60 J/g, though likely much higher with annealing to full recrystallization from melt indicated by cold-crystallization events upon heating above the glass transition temperature (T_{g}) when analyzed by dynamic scanning calorimetry (DSC) (see Panel B of FIG. 30 and FIG. 31). In addition, temperature-ramp frequency sweep thermograms by dynamic mechanical analysis (DMA) of PHBU agreed with thermal events measured by DSC in reflecting a failure in film integrity near the Tₘ region ˜145° C. (see FIG. 32), while also highlighting impressive storage modulus (E′) values of 8274 MPa at −80° C. (E′ₘₐₓ) and 2272 MPa at ˜23° C. (E′_{RT}), supporting the brittleness (−80 to 175° C., 3° C. min⁻¹, 30 μm, 1 Hz, see Panel C of FIG. 30 and Panel A of FIG. 33). Lastly, the decomposition profile of PHBU was evaluated by thermogravimetric analysis (TGA) (sec FIG. 34), revealing a low decomposition temperature.

Recognizing that crosslinking this material at the alkene positions would only impart higher stiffness, generating physical blends of scl-co-mcl PHBU with mcl-co-mcl unsaturated analogue PHDU was evaluated (see Panel A of FIG. 30). To this end, we blended the hard PHBU with the soft PHDU in varying incorporations of 3:1, 1:1, and 1:3 (by weight), respectively, with the goal of obtaining a range of thermomechanical profiles.

TABLE 5
Properties of the pooled PHBU

| | % U | T_{g} | Tₘ^{b} | Mₙ^{c} | | |
|---|---|---|---|---|---|---|
| Name | NMR^{a} | (° C.) | (° C.) | kDa | Ð | Source |
| PHBU-Bioreactors | 4 | | | 264 | 1.95 | Bioreactors |
| PHBU-Shake flasks | 5 | | | 174 | 1.82 | Shake flasks |
| PHBU-pooled | 5 | 0-3 | 150, 160 | 245 | 1.85 | Combined |

In general, each reaction using different ratios of PHBU:PHDU was completed as follows. A 100 mL round-bottom flask was charged with PHBU-5, PHDU-6, and Bis-BE-SH (5 equiv. SH:ene) in a glovebox. DMPA (0.5 wt % relative to polymer) and degassed, anhydrous, inhibitor-free DCM were added under a positive flow of nitrogen on a Schlenk line. The flask was placed in an air-cooled photoreactor (365 nm LED light) and irradiated for 2 hours. After the reaction, most of the DCM was removed in vacuo, and the mixture was precipitated in anhydrous methanol. The polymer was collected and dried in a vacuum oven at 40° C. for 24 hours.

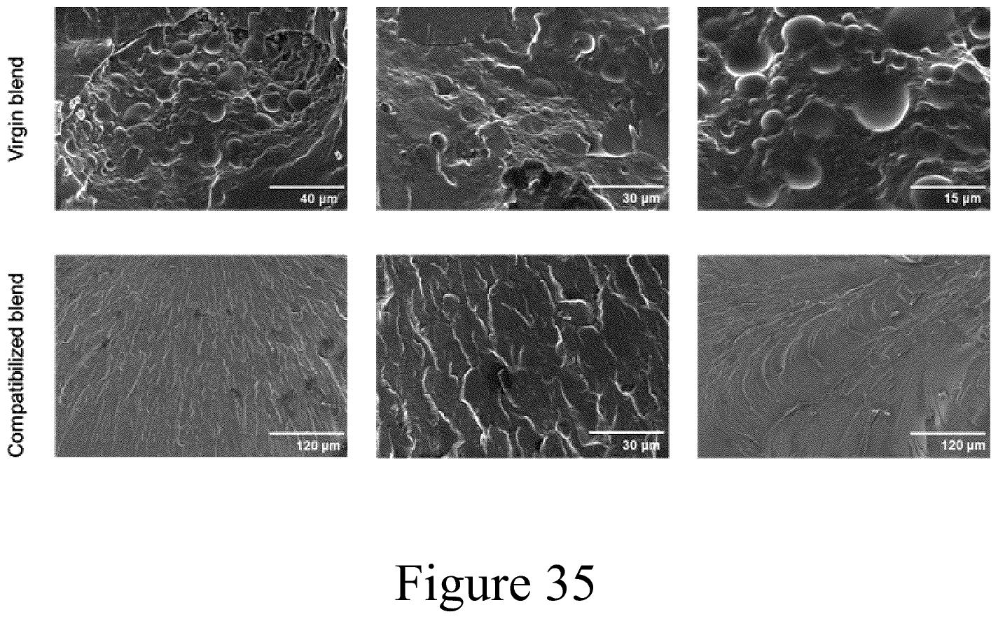

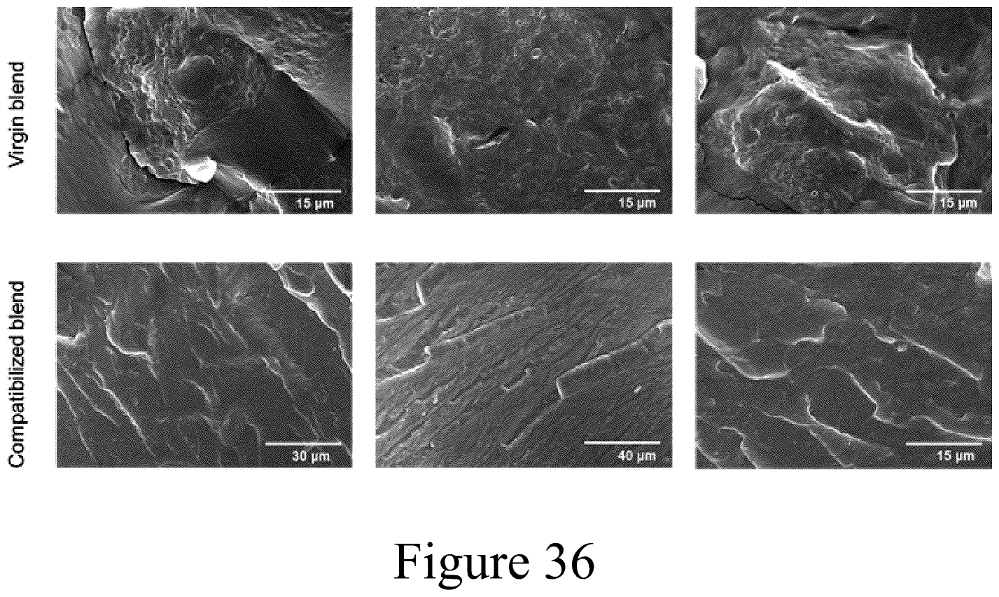

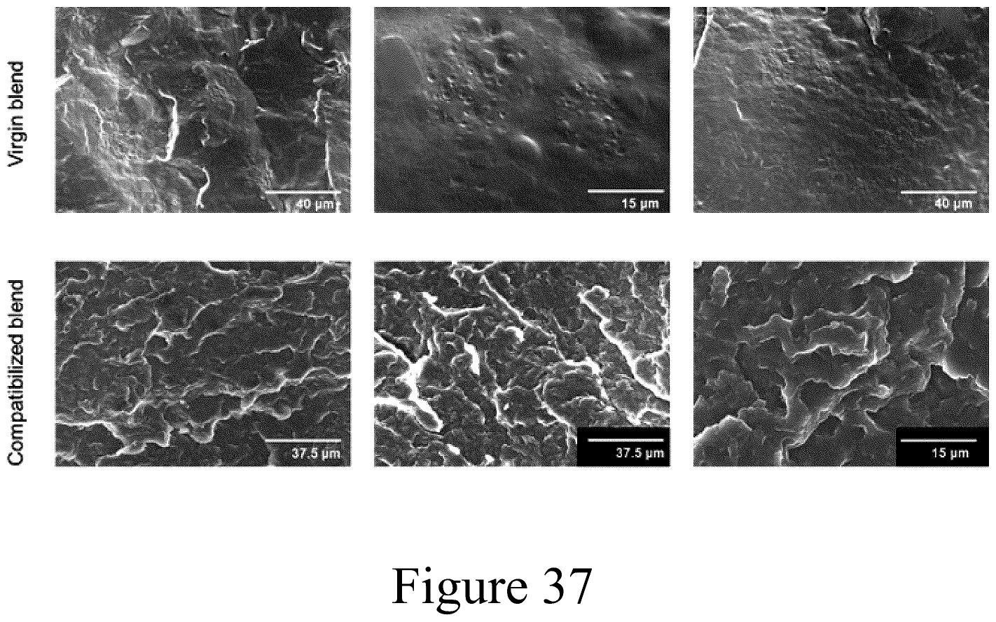

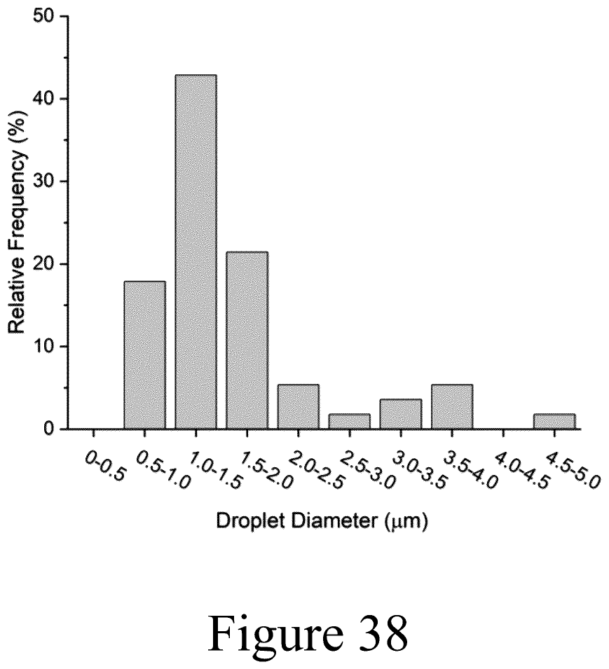

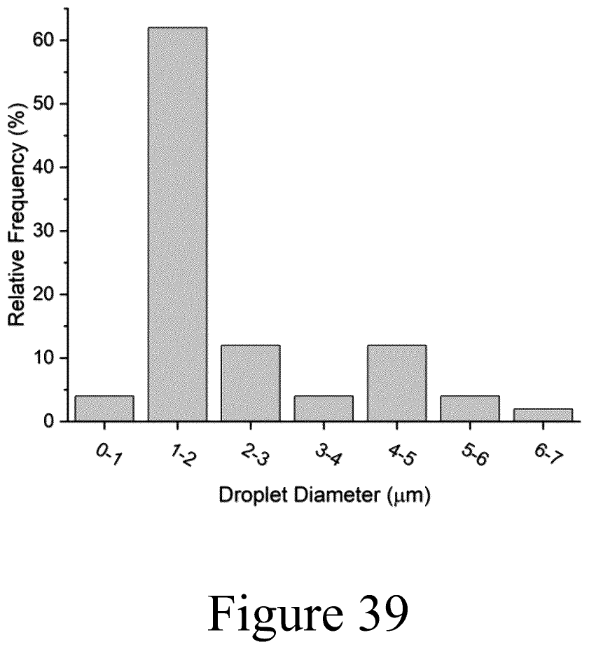

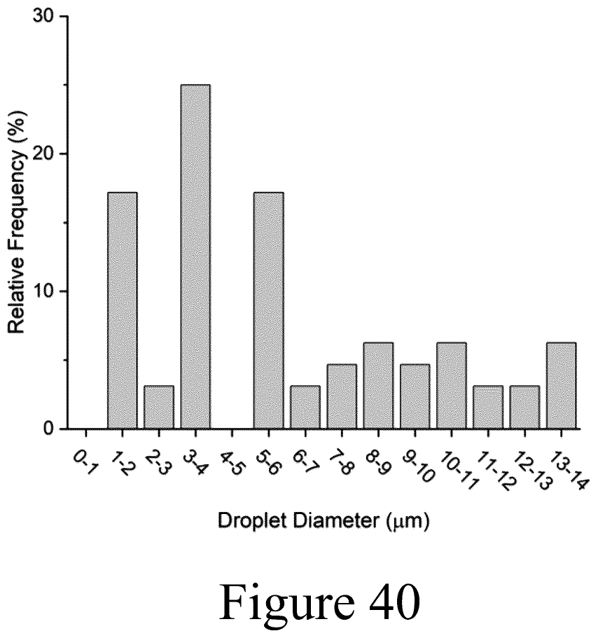

Initial analysis by scanning electron microscopy (SEM) at the cryo-fractured cross-section, however, revealed a pool of phase-separated PHBU and PHDU in the traditional form of droplet-style domains buried in the host-polymer matrix (see Panel E of FIG. 30). Notably, a trend in reduced compatibility was found with increasing the composition of PHDU in the blend, as the highly crystalline PHBU domains were less likely to miscibilize with the amorphous regions. Specifically, droplet size analysis revealed that upon increasing PHDU content from 25 mol % to 50 mol % to 75 mol % paralleled an increasing average droplet diameter (see Panel E of FIG. 30 and FIGS. 35-40).

The presence and corresponding size metric of droplets is a direct indicator for film integrity and thermomechanical performance, as the low interfacial adhesion (high interfacial tension) between the two immiscible polymers reduces stress resistance. The droplet diameter can also be used as a metric for impact, as larger diameters reflect poor mixing or homogeneity and smaller or lack of droplet presence signals good miscibility and thus ideal delocalized tension between the copolymer species. With this in mind, the usPHA pendant functionality was leveraged to install dynamic crosslinks. To this end, simple UV-photoinitiated thiol-ene click chemistry was performed on 3 g scales for the 3:1, 1:1, and 1:3 usPHA blends (PHBU:PHDU as weight ratios) in solution to covalently link the unsaturated pendant groups on both PHBU and PHDU with Bis-BE-SH, which is capable of performing boronic ester metathesis for network reconfiguration (see Panel A of FIG. 30). Upon revisiting the dynamic thermoset blends with SEM, melt-processed film cross-sectional interfaces revealed homogenized surfaces in complete absence of differentiable micro-domains, signaling compatibilization achieved via tethering the parent polymer chains precluding phase separation behavior upon cooling (see Panel E of FIG. 30 and FIGS. 35-37).

Synthesized resins displayed a range of thermal properties from crystalline (3:1), to semi-crystalline (1:1), to fully amorphous (1:3) (see Panel B of FIG. 30). Successful installation of the dynamic crosslinks was supported by DMA thermograms for each of the three blends, revealing extended thermomechanical performance windows in the rubbery plateau (ΔE′˜0) region beyond the PHBU parent polymer's ˜145° C. melt-failure due to the associative nature of the boronic ester exchange retaining a constant crosslink density during metathesis events (−80 to 200° C., 3° C. min⁻¹, 30 μm, 1 Hz, see Panel C of FIG. 32). Importantly, tensile stress/strain (5 mm min⁻¹, ˜23° C.) revealed a wide range of thermoset properties dramatically outperforming the brittle parent PHBU. Specifically, a hard rubber (σ_{B}=15.0 MPa, ε_{B}=21.9%, E=665 MPa) was obtained from the compatibilized 3:1 blend, a firm plastic-like response (σ_{B}=6.6 MPa, ε_{B}=92.7%, E=70 MPa) was obtained from the compatibilized 1:1 blend, and a softer ductile elastomer (σ_{B}=2.0 MPa, ε_{B}=187%, E=6.8 MPa) was obtained from the compatibilized 1:3 blend (PHBU:PHDU) (see Panel D of FIG. 30). Similar observations were made through the DMA thermograms for the 3:1, 1:1 and 1:3 blends where a clear trend in decreasing E′ₘₐₓ of 4922 MPa, 3985 MPa, and 2981 MPa, respectively, is shown with decreasing hard-component PHBU blend contribution (see Panel C of FIG. 30). Tables 6A, 6B, an 6C summarize the physical properties and performance metrics for the various PHBU, PHDU, and PHBU-blend-PHDU materials described herein.

TABLE 6A
Material Properties and Performance Metrics Summary

| | cross- | U [alkene | Mₙ | | T_{g} | Tₘ |
|---|---|---|---|---|---|---|
| Sample | linker | mol %] | [kDa] | Ð | [° C.] | [° C.] |
| PHDU-6 | none | 6 | 172 | 1.6 | −46 | 34, 60 |
| PHDU-22 | none | 22 | 186 | 1.6 | −51 | 30, 59 |
| PHDU-6-sat | none | 0 | 165 | 1.8 | −46 | 31, 60 |
| PHBU-5 | none | 5 | 124 | 1.9 | −5.1 | 150 |
| PHDU-BE-6 | Bis-BE-SH | 6 | — | — | −36-−38 | 56-67 |
| PHDU-BE-22 | Bis-BE-SH | 22 | — | — | −19 | — |
| PHBU₃-blend-PHDU₁ | Bis-BE-SH | 5/6 | — | — | −39, −0.1 | 158 |
| PHBU₁-blend-PHDU₁ | Bis-BE-SH | 5/6 | — | — | −39, −3.9 | 156 |
| PHBU₁-blend-PHDU₃ | Bis-BE-SH | 5/6 | — | — | −39, −3.9 | — |

TABLE 6B
Material Properties and Performance Metrics Summary

| | T_{d, 5} | Processing | E | ε_{B} | σ_{B} | degradation^{d} |
|---|---|---|---|---|---|---|
| Sample | [° C.] | T [° C.] | [MPa]^{a} | [%]^{b} | [MPa]^{c} | (%) |
| PHDU-6 | 288 | — | — | — | — | 24 |
| PHDU-22 | 285 | — | — | — | — | — |
| PHDU-6-sat | 283 | 110-160 | 4.58 | 379 | 14.2 | — |
| PHBU-5 | 246 | 165 | 830 | 18 | 20 | 24 |
| PHDU-BE-6 | 270-290 | 110-160 | 1.72-2.00 | 222-333 | 1.73-15.93 | 40 |
| PHDU-BE-22 | 281-283 | 110-160 | 4.8-5.7 | 10.9-18.5 | 0.50-0.58 | — |
| PHBU₃-blend-PHDU₁ | ~270 | 165 | 665 | 21.9 | 15 | 24 |
| PHBU₁-blend-PHDU₁ | ~270 | 165 | 70 | 92.7 | 6.6 | — |
| PHBU₁-blend-PHDU₃ | ~270 | 165 | 6.8 | 187 | 2 | 21 |

^{a}Young's Modulus;
^{b}ductility;
^{c}strength at break;
^{d}freshwater % biodegradation at 90 days.

TABLE 6C
Material Properties and Performance Metrics Summary

| | cross- | | Mₙ | a or d [# sat. | b or e [# unsat. |
|---|---|---|---|---|---|
| Sample | linker | U | [kDa] | repeat units] | repeat units] |
| PHDU-6 | none | 6 | 172 | 940 | 60 |
| PHDU-22 | none | 22 | 186 | 833 | 235 |
| PHBU-5 | none | 5 | 124 | 1292 | 68 |
| PHBU- | none | 4 | 264 | 2808 | 117 |
| Bioreactors | | | | | |
| PHBU- | none | 5 | 174 | 1824 | 96 |
| Shake flasks | | | | | |

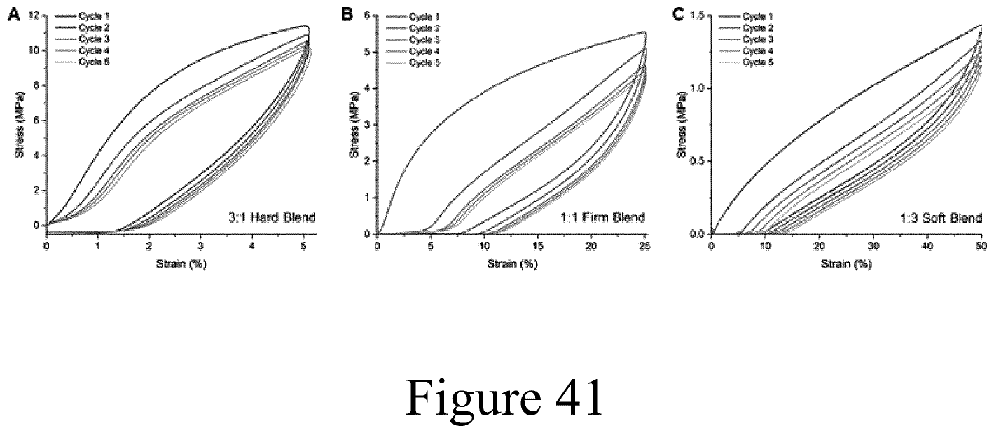

Lastly, the thermoset materials resulting from the reacted blends of PHDU and PBHU were subjected to conventional elastomer hysteresis analysis to observe deformation recovery following cyclic stress loadings. Worth noting, the strain for deformation was varied between 5-50% in accordance with the ultimate strain obtained from initial tensile pulling tests. Following five cycles of load-unload cyclic ramps, the ultimate stress was retained at 89%, 80%, and 81% of the initial first cycle value on the 3:1 hard, 1:1 firm, and 1:3 soft crosslinked blends, respectively, highlighting moderate crosslink shape-memory behavior following rapid extension events (50 mm min⁻¹ up/down ramp rate) (see FIG. 41). Higher crosslink density may allow for higher elasticity for these events, though possibly with a consequence of lowering ductility. Overall, the high tunability of these thermomechanical profiles to the thermal properties for these materials may be attributed to higher crystallinity providing higher strength and lower ductility. Thus, the copolymer chemical-crosslinking compatibilized blend approach is a useful and effective strategy for producing melt-processable and biodegradable thermosets with access to a wide range of physical properties and performance metrics.

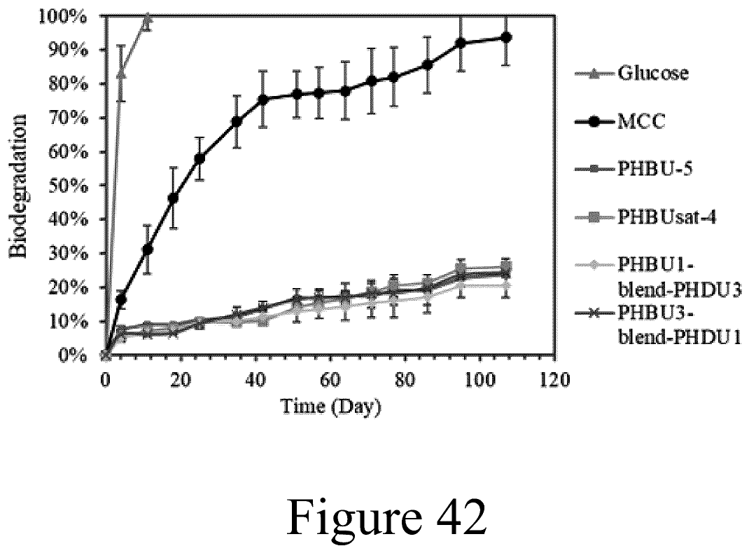

To assess the biodegradability of the aforementioned PHA films, biodegradation studies in freshwater environment were conducted, adhering to ISO 14851 standard. Additionally, to evaluate the influence of the terminal alkene group on PHBU's biodegradability, its saturated counterpart was included, poly-(R)-3-hydroxyburytate-co-3-hydroxyundecanoate, with a 4% molar ratio of 3-hydroxyundecanoate (PHBUₛₐₜ-4). In this context, PHBU-5 reached 23.77±3.35% biodegradation, PHBUₛₐₜ-4 reached 26.08±2.38% biodegradation, PHBU₁-blend-PHDU₃ reached 20.62±3.65% biodegradation, and PHBU₃-blend-PHDU₁ reached 24.27±0.61% biodegradation over a span of 107 days (see FIG. 42). First-order kinetics were used to estimate the lifetime of these films in freshwater environments. The calculated projections indicate that PHBU-5 is expected to achieve 90% biodegradation in approximately 1182 days, PHBUₛₐₜ-4 in approximately 915 days, PHBU₁-blend-PHDU₃ in approximately 1295 days, and PHBU₃-blend-PHDU₁ in approximately 1022 days (see Table 7).

TABLE 7
Summary of estimated lifetime of PHBU film
samples using first order kinetic model.

| | | Estimated 90% | |
|---|---|---|---|
| | Rate constant | biodegradation | |
| Sample | (day⁻¹) | time (day) | R² |
| PHBU-5 | 0.001891 | 1182 | 0.9733 |
| PHBUₛₐₜ-4 | 0.002480 | 915 | 0.9661 |
| PHBU₁-blend-PHDU₃ | 0.001741 | 1295 | 0.9859 |
| PHBU₃-blend-PHDU₁ | 0.002209 | 1022 | 0.9727 |

These results suggest that if these films were to be released into freshwater environments, they would degrade within a predicted timeframe of two to four years. Statistical analysis revealed no significant difference in their biodegradation rates in this freshwater environment (p>0.05), suggesting that our dual approach does not affect the biodegradability of related materials, exhibiting promise of achieving sustainable production. Notably, all four films exhibit a dual-stage degradation pattern, with accelerated biodegradation observed around day 20 and another spike around day 80. This feature is potentially related to the degradation of different segments (e.g., amorphous versus crystalline, short chain versus long chain) or components (e.g., PHBU, PHDU) of the blends.

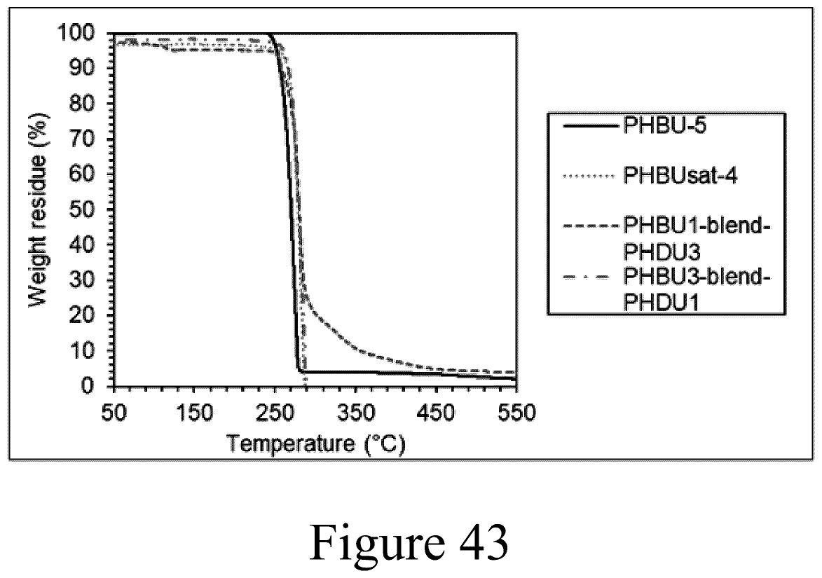

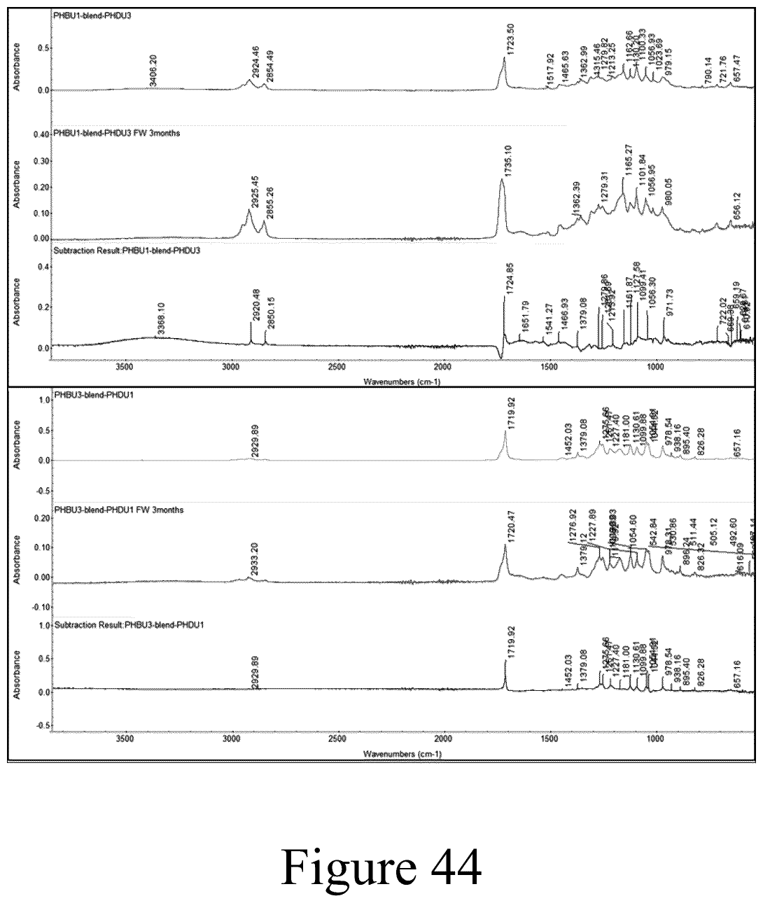

To evaluate changes in the relevant PHA films post-biodegradation, thermogravimetric analysis (TGA) was performed. Prior to TGA analysis, the free-flowing water on the surface of polymers was removed by gently wiping with paper towel. Under a nitrogen atmosphere, the post-biodegradation films exhibited less than 5% weight loss at 150° C., followed by a distinct depolymerization weight loss pattern between 250-270° C. with less than 5% residue (see FIG. 43). Notably, PHBU₁-blend-PHDU₃ displayed a relatively higher residue, presumably due to its higher PHDU content. Additionally, Fourier-transform infrared (FTIR) analysis was completed to characterize the PHA films pre- and post-biodegradation in freshwater environment, aiming to elucidate changes in their chemical composition. Spectral data were subjected to subtraction (pre-biodegradation minus post-biodegradation) to illustrate variations in relative peak intensities. Negative peaks observed in the subtraction spectra were attributed to moisture (3300 and 1650 cm⁻¹) and nitro content (1540 cm⁻¹), originating from the inoculum or aqueous media post-freshwater biodegradation. For all four films, peaks at wavenumbers of 1720 cm⁻¹ (C═O vibration), 1277 cm⁻¹ (C—H plane bending), and 1179 cm⁻¹ (C—O stretching) displayed more noticeable decrease compared to peaks in the range of 2800-3000 cm⁻¹ (C—H stretching) and 1300-1600 cm⁻¹ (methylene C—H bending) (see FIG. 44). In summary, these findings provide valuable insights into the chemical transformations of these materials during biodegradation and offer promising implications for the development of materials with tailored biodegradability characteristics across a range of applications.

### Experimental Methods

Chemicals: The following chemicals were purchased from Sigma Aldrich and used as received: sodium decanoate, 10-undecenoic acid, chloroform (ethanol inhibitor), methanol (anhydrous Sure/Seal™), THF (anhydrous Sure/Seal™, inhibitor-free), DMSO-d₆ thioglycerol, magnesium sulfate (anhydrous Redi-Dri™), 2,2-dimethoxy-2-phenylacetophenone (DMPA), benzene-1,4-diboronic acid, pentaerythritol tetrakis(3-mercaptopropionate), and 1,2-propanediol.

Photoreactors: 100 mg scale reactions were performed inside a Hepatochem PhotoRedOx Box™ photoreactor equipped with a 365 nm light bulb and air cooling. The photoreactor was placed on top of a stir plate and reactions were performed in 20 mL vials.

A homemade photoreactor was constructed to accommodate larger volume reactions. The lower portion of a 2 L heavy-walled beaker was wrapped with a 3-meter strip of flexible 365 nm LEDs from Waveform Lighting. The outside of the beaker was then wrapped with reflective mylar sheeting, including a removable lid with a notch cut out for the cooling air tube. An inverted petri dish (˜1 cm high) was used to elevate the flask to align with the light source. During use, the beaker was placed on top of a stir plate, a cooling air tube was taped to the inside of the beaker, and the lid was taped closed. Flat-bottomed flasks were used to obviate the need for clamps. Light intensity measurements were taken without the lid and read 5-10 mW/cm² in the center of the reactor.

Thermogravimetric Analysis (TGA). TGA was performed using a TA Instruments TGA-5500 at a heating rate of 20° C./min under 50 mL/min of N₂ gas. The onset degradation temperature was determined using Trios software, defined at 5% mass loss (T_{d,5}). Derivative curves were generated automatically by Trios software.

Differential Scanning calorimetry (DSC). DSC studies were conducted using a TA Instruments DSC-Q2000 or DSC-25 and analyzed with Trios software. Exotherms are in the upward direction for all DSC figures.

Dynamic Mechanical Analysis (DMA). DMA experiments (modulus vs. temperature, elastic hysteresis) were performed on a Q800 DMA Analyzer (TA Instruments). Samples for DMA were prepared in controlled fashion (w=5.40 mm, t=0.5-1.0 mm) with length measured within the grips by the Q-series measurement software (TA) before each experiment. Grips were carefully tightened between 1-3 lbs-in in accordance with the samples' low modulus. Temperatures below ambient were achieved by liquid-nitrogen GCA tank attachment (TA). Temperature ramp frequency sweeps were conducted at a strain of 0.3% at a frequency of 1 Hz between −50-200° C. (or to failure) at a heating rate of 5° C./min.

Compression Molding. Compression molding was performed using a Carver press [model/details]. Bulk polymer (0.5-0.6 g per specimen) was placed in a stainless-steel frame with ASTM type V dog bone-shaped cutouts (0.8 mm thickness) and placed between two aluminum sheets lined with Teflon paper. Linear PHDUsat samples were compression molded at 80° C. for 10 minutes and ˜6,000 psi and were cooled slowly in the hot press overnight. Crosslinked PHDU-BE specimens were processed under similar conditions but higher temperatures of 110-160° C., 10-30 minutes.

Tensile Testing. Tensile testing was conducted on an Instron 5900 Series tensiometer equipped with a 1 kN load cell. A strain rate of 10 mm/min was used at ambient temperature using triplicate specimens. Data was automatically generated and processed using Bluchill Universal Software.

Oscillatory shear rheology. Bulk flow experiments were performed on a Discovery Series Hybrid 2 (DHR-2) Rheometer (TA Instruments). Circular discs (25 mm) of polymer films were loaded between two 25 mm steel parallel-plate EHP geometries under N₂ (30 psi) gas flow and allowed to soak at specified temperatures for a minimum of 5 min. Axial forced was controlled to ±0.2 N, and gap size was regulated prior to the experiment initiation. Rheometer control and data analysis were performed with the TA Instruments TRIOS Software. Creep-recovery was conducted under 1kPa in triplicate temperature 60, 100, and 125° C. (all above Tₘ) for a 10-minute creep duration and a 5-minute recovery period. Bulk viscosity measurements were recorded at 175° C. between shear rates 0.1 to 1000 s⁻¹. Stress relaxation was performed over 2000 s with a 1 s rise time to a strain of 0.3% between 80-150° C. in increments of 5° C. (15 total). Raw stress relaxation curves were transformed to normalized modulus plots (Gₒ=G′/G′ₘₐₓ) and were subsequently fitted to an exponential decay curve from which the signature polymer relaxation time (τ) at 1/e normalized modulus (˜0.37) can be derived or extrapolated to. Finally, an Arrhenius relationship can then be struck up from the set of τ(s) and the corresponding temperatures (1000/T(K)) revealing the activation energy for the boronic ester-PHDU system.

PHA Extraction. Lyophilized biomass was stirred vigorously with excess CHCl₃ (5-10× volume per gram biomass) for 24 h such that all pellets became fully pulverized. The mixture was then filtered through glass fiber circle filter papers (Fisherbrand), then through a 0.2 μm PTFE membrane. The dilute chloroform-PHA solution was then concentrated on the rotary evaporator until viscous, then poured slowly into stirring, chilled ethanol (>10× ethanol:CHCl₃). The precipitated polymer was isolated by decanting and/or filtration. Ethanol was also poured into the original flask to precipitate polymer that remained on the walls. Residual solvent was removed in a 37° C. vacuum oven for ˜24 h. If the alcohol portion of the precipitation mixture was opaque (versus slightly cloudy), additional pure polymer was isolated by reducing the alcohol volume on the rotary evaporator until further precipitation occurred. Precipitation and drying was repeated as needed to obtain colorless, spectroscopically pure polymer (typically 3-4×). Percent yield by cell dry weight (CDW) was not applicable to bioreactor fermentations, as the PHDU broth did not centrifuge effectively, and the entire broth was freeze-dried and extracted. Products of three bioreactors were purified separately prior to a final pooling in CHCl₃ and subsequent precipitation to deliver a single batch of PHDU.

Purified usPHAs were stored in an N₂-filled glovebox in amber Nalgene bottles to prevent aging over the course of this work. The bottles were removed temporarily from the glovebox to weigh out substrates for post-functionalization reactions.

Crosslinker Synthesis: 2,2-(1,4-Phenylene)-bis[4-thioethyl-1,3,2-dioxaborolane] (Bis-BE-SH). Literature procedure was followed with an added purification step to remove excess starting material, benzene-1,4-diboronic acid (CDCl₃ invisible, DMSO-d₆ soluble). After initial isolation, the crude product was dissolved in chloroform and filtered until clear. After rotary evaporation, the product was confirmed to be pure by ¹H NMR in DMSO-d₆ and stored in an N₂-filled glovebox.

PHDU Crosslinking by UV Thiol-Ene reaction. 100 mg scale: A 20 mL vial was charged with 100 mg PHDU-6 (0.035 mmol alkene*), 5 mL anhydrous THF (inhibitor-free), a stir bar, and the desired quantity of thiol relative to mmol alkene (27 mg Bis-BE-SH, 0.088 mmol, 5 equiv. SH:ene). Once dissolved, a 0.5 wt % loading of DMPA photoinitiator relative to polymer was delivered by injecting 50 μL of ˜10 mg/mL stock solution (THF). The vial was placed in the photoreactor (365 nm LED light source) with air cooling and irradiated at ambient temperature for 1h with stirring. After reaction, most THF was removed by rotary evaporation and the crude product was washed with portions of anhydrous methanol (˜25 mL total), then dried in a vacuum oven at 37° C. for 24 h. After this point, no further efforts were made to exclude moisture.

*mmol alkene is calculated by:
1) finding mmol copolymer in a sample of given mass via average molecular weight:

MW_{copolymer}=(MW_{decanoate})*(X_{decanoate})+(MW_{undecenoate})*(X_{undecenoate})

Example: PHDU-6 MW=(170.27)(0.94)+(182.28)(0.06)=170.99 g/mol

(0.1 g copolymer)*(1 mol/170.99 g)*1000=0.585 mmol PHDU-6
2) finding mmol alkene in the sample by: (mmol copolymer)*(mol % alkene)

(0.585 mmol PHDU-6)*(0.06 alkene)=0.035 mmol alkene

3.0 g scale: A 250 mL flat-bottom flask with a stir bar was oven dried and cooled under N₂. Once cooled, 3.0 g PHDU-6 (1.05 mmol alkene) and 150 mL anhydrous THF were added to the flask followed by Bis-BE-SH (816 mg Bis-BE-SH, 2.63 mmol, 5 equiv. SH:ene). Once dissolved, a 0.5 wt % loading of DMPA photoinitiator relative to polymer (15 mg) was added and the flask sealed with a rubber septum. Out of caution, the reaction was degassed for 15 minutes while wrapped in foil by N₂ sparging from the Schlenk line. The sparge needles were removed and the flask was transferred to the photoreactor and irradiated at 365 nm for 1 hour with vigorous stirring (˜600 rpm) and air cooling. After reaction, most THF was removed by rotary evaporation and the crude product was washed with portions anhydrous methanol (80-100 mL total) until low or zero thiol odor, then dried in a vacuum oven at 37° C. for 24 hours. After this point, no further efforts were made to exclude moisture.

Polymer isolation and purification. Lyophilized biomass was stirred vigorously in CHCl₃ for 24 h. The mixture was filtered through Chemrus® disposable 10 μm pore size filter funnel and then through a 0.2 μm PTFE filter frit. The polymer solution was concentrated on the rotary evaporator until viscous, then precipitated from cold ethanol. The polymer was recovered by filtration and dried in a vacuum oven at 40° C. for 24 h.

Nuclear Magnetic Resonance (NMR) Spectroscopy. ¹H and ¹³C spectra of linear polymers were recorded on a 400 MHz Bruker instrument (FT 400 MHz, ¹H; 101 MHz, ¹³C) at ambient temperature. Chemical shifts were referenced to internal solvent resonances and reported as parts per million (ppm) relative to tetramethylsilane. A delay (d1) time of 30 seconds was required for accurate quantification of mol % U in PHBU.

Gel Permeation Chromatography. The GPC instrument consisted of an Agilent HPLC system equipped with one guard column and three PLgel 5 μm mixed-C gel permeation columns and coupled with a Wyatt DAWN HELEOS II multi (18)-angle light scattering detector and a Wyatt Optilab TrEX dRI detector; the analysis was performed at 40° C. using chloroform as the eluent at a flow rate of 1.0 mL min⁻¹, using Wyatt ASTRA 7.1.3 molecular weight characterization software. In place of a dn/dc value, exact concentrations of purified polymers were used with assumption 100% mass recovery to calculate absolute molecular weight using Astra software.

Biodegradation Testing. The biodegradability of polymer samples in a freshwater environment was assessed following ISO 14851 methodology. Polymer film samples, including PHBU-5, PHBUₛₐₜ-4, PHBU₁-blend-PHDU₃, and PHBU₃-blend-PHDU₁ (approximately 4 mm×3 mm×1 mm in size), were tested in triplicates within 300 mL biological oxygen demand (BOD) glass bottles (VWR International). In each BOD bottle, activated sludge from a wastewater treatment plant (Lemont, IL, USA) was combined with 200 mL of aqueous medium, which was composed of the following components (in mg/L): KH₂PO₄, 85; K₂HPO₄, 217.5; Na₂HPO₄, 334; NH₄Cl, 15; MgSO₄·7H₂O, 22.5; CaCl₂·2H₂O, 36.4; and FeCl₃·6H₂O, 0.25. The total solid from sludge was 60 mg/L. For each of the triplicate test bottles of polymer samples, PHBU-5, PHBUₛₐₜ-4, PHBU₁-blend-PHDU₃, and PHBU₃-blend-PHDU₁ film samples (approximately 4 mm*3 mm*1 mm size) were added to the BOD bottles. Total organic carbon from polymer samples (PHBU-5, PHBUₛₐₜ-4, PHBU₁-blend-PHDU₃, and PHBU₃-blend-PHDU₁) added to every test bottle was 9.0 mg. Three blank test bottles with no additional carbon content other than the aqueous medium and three positive control bottles with 9.0 mg total organic carbon content from D-glucose (Fisher Scientific, granular powder) and cellulose (microcrystalline, particle size 0.05 mm, Acros Organics) were also set up. All bottles were incubated in a New Brunswick Scientific incubator shaker (Eppendorf, model I-24) at 25° C. and 150 rpm. BOD was determined by measuring oxygen consumption using a pH/RDO/DO meter (Thermo Fisher Scientific, model Orion Star A216) based on the conditions listed in ISO 14851 standard method. The percentage biodegradability of the sample was calculated as

$$\% Biodegradation = \frac{{BOD}_{sample} - {BOD}_{blank}}{c \times ThOD} \times 100 \% \qquad Equation 1$$

The observed values of BODₛₐₘₚₗₑ and BOD_{blank}were recorded for sample and blank bioreactor, respectively. The amount of sample added, denoted as ‘c,’ was carefully measured. ThOD, representing the theoretical oxygen demand value of the sample, was calculated based on the chemical formula, assuming complete oxidation of the polymer sample. It was required by the protocol that the positive control (glucose) reach a biodegradation level of 60% at the conclusion of the test, and that the standard deviation of each sample be less than 20% of the mean.

Estimation of End of Lifetime. A first-order kinetic model was employed to calculate the biodegradation rate and predict the lifespan of the polymer samples in a freshwater environment.

% Biodegradation=1−e^{(-kt+C)} Equation 2

Equation 2 was utilized to create a plot of percentage biodegradation against time. Within the equation, k represented the rate constant, t denoted reaction time, and C was a constant from the plot. Table 7 provides a summary of the rate constants and estimated times to reach 90% biodegradation in freshwater environment, and R² values indicating the fitness of the model.

TGA in biodegradation test section. TGA of the sample films was performed using an STA 449 F3 model thermal analyzer (Netzsch, Selb, GER) from room temperature to 550° C. under nitrogen (Airgas, 99.99%, Radnor, PA, USA) with a heating rate of 5° C. per minute.

Fourier-transform infrared analysis. Fourier-transform infrared (FTIR) analysis was performed by using a Nicolet iS20 FTIR Spectrometer (Thermo Scientific, Waltham, MA, USA). The FTIR spectra were obtained as an average of 50 scans per sample across the 4000-400 cm⁻¹ spectral range.

### EXAMPLES

Example 1. A composition comprising: a first copolymer comprising a first repeat unit and a second repeat unit as defined by Structure (I)

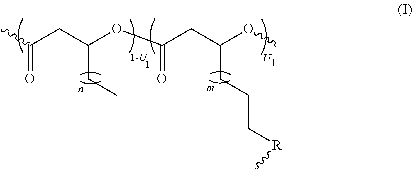

wherein: [symbol] is a covalent bond, UI is a molar fraction of the first repeat unit (unsaturated), (1−U₁) is a molar fraction of the second repeat unit (saturated), 0≤n≤20, 0≤m≤20, 0<U₁≤1.0, R is a linking group covalently linking the first copolymer to a second copolymer by the covalent bond, and R comprises carbon, hydrogen, and sulfur.

Example 2. The composition of Example 1, wherein the first copolymer has a molecular weight (Mₙ) between 100 kDa and 1000 kDa.

Example 3. The composition of either Example one or Example 2, wherein Mₙ is between 160 kDa and 200 kDa.

Example 4. The composition of any one of Examples 1-3, wherein Mₙ is between 165 kDa and 186 kDa, inclusively.

Example 5. The composition of any one of Examples 1-4, wherein the first

copolymer has a molecular weight dispersity (Ð) between 1.0 and 2.0.

Example 6. The composition of any one of Examples 1-5, wherein Ð is between 1.40 and 1.90.

Example 7. The composition of any one of Examples 1-6, wherein Ð is between 1.55 and 1.76, inclusively.

Example 8. The composition of any one of Examples 1-7, wherein n is between 0 and 9, inclusively.

Example 9. The composition of any one of Examples 1-8, wherein n is 6.

Example 10. The composition of any one of Examples 1-9, wherein m is between 0 and 9, inclusively.

Example 11. The composition of any one of Examples 1-10, wherein m is 6.

Example 12. The composition of any one of Examples 1-11, wherein 0.01<U₁<0.50.

Example 13. The composition of any one of Examples 1-12, wherein 0.06≤U₁≤0.22.

Example 14. The composition of any one of Examples 1-13, wherein n is 6, m is 7, and 0.06≤U₁≤0.22.

Example 15. The composition of any one of Examples 1-14, wherein a represents the number of second repeat units (saturated) present in the first polymer and 500≤a≤1500.

Example 16. The composition of any one of Examples 1-15, wherein 800≤a≤1000.

Example 17. The composition of any one of Examples 1-16, wherein b represents

the number of first repeat units (unsaturated) present in the first polymer and 10≤b≤500.

Example 18. The composition of any one of Examples 1-17, wherein 50≤b≤250.

Example 19. The composition of any one of Examples 1-18, wherein the first copolymer is derived from poly-R-(3-hydroxydecanonate-co-3-hydroxyundecenoate) (PHDU).

Example 20. The composition of any one of Examples 1-19, wherein R further comprises at least one of oxygen or boron.

Example 21. The composition of any one of Examples 1-20, wherein R comprises at least one of

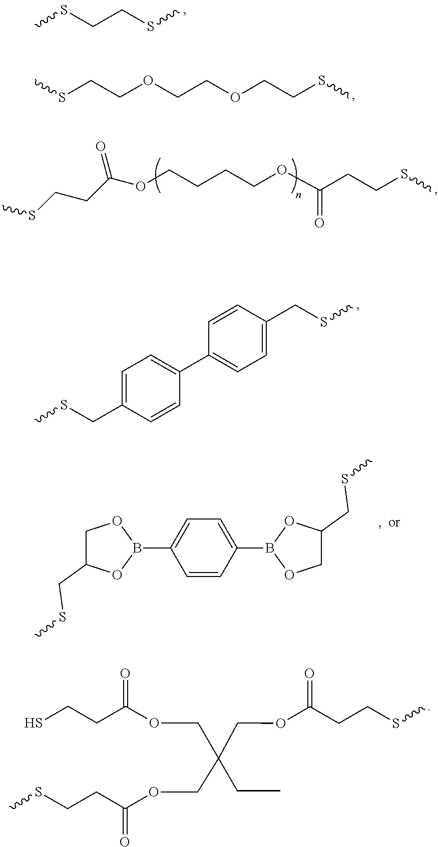

Example 22. The composition of any one of Examples 1-21, wherein R is

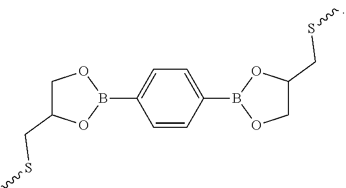

Example 23. The composition of any one of Examples 1-22, wherein R is derived from 2,2′-(1,4-phenylene)-bis[4-thioethyl-1,3,2-dioxaborolane (Bis-BE-SH).

Example 24. The composition of any one of Examples 1-23, wherein the second copolymer comprises Structure (I).

Example 25. The composition of any one of Examples 1-24, wherein the second copolymer comprises Structure (II)

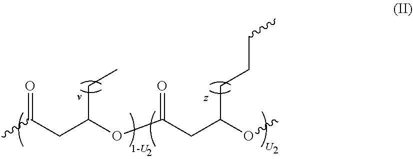

wherein: U2 is a molar fraction of a third repeat unit, (1−U2) is a molar fraction of a fourth repeat unit, 0≤v≤20, 0≤z≤20, and 0<U₂≤1.

Example 26. The composition of any one of Examples 1-25, wherein v is between 0 and 9, inclusively.

Example 27. The composition of any one of Examples 1-26, wherein v is zero.

Example 28. The composition of any one of Examples 1-27, wherein z is between 0 and 9, inclusively.

Example 29. The composition of any one of Examples 1-28, wherein z is 6.

Example 30. The composition of any one of Examples 1-29, wherein 0.01<U₂<0.50.

Example 31. The composition of any one of Examples 1-30, wherein 0.01≤U₂≤0.10.

Example 32. The composition of any one of Examples 1-31, wherein v is zero, z is 6, and 0.04≤U₂≤0.05.

Example 33. The composition of any one of Examples 1-32, wherein d represents the number of second repeat units (saturated) present in the first polymer and 1000≤d≤3200.

Example 34. The composition of any one of Examples 1-33, wherein 1200≤d≤3000.

Example 35. The composition of any one of Examples 1-34, wherein e represents the number of first repeat units (unsaturated) present in the first polymer and 10≤e≤200.

Example 36. The composition of any one of Examples 1-35, wherein 50≤e≤150.

Example 37. The composition of any one of Examples 1-36, wherein the second copolymer chain is derived from (poly-(R)-3-hydroxyburytate-co-3-hydroxyundecanoate (PHBU).

Example 38. The composition of any one of Examples 1-37, wherein the first copolymer and the second copolymer are at a mass ratio between 1:10 and 10:1 (first copolymer:second copolymer), inclusively.

Example 39. The composition of any one of Examples 1-38, wherein the ratio is between 1:3 and 3:1, inclusively.

Example 40. The composition of any one of Examples 1-39, wherein: Structure (I) further comprises a fifth repeat unit comprising Structure (III)

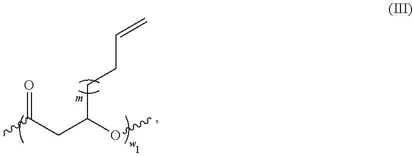

W₁ is a molar fraction of a fifth repeat unit, 0≤W₁<0.1, and (1−U₁−W₁) is a molar fraction of the second repeat unit.

Example 41. The composition of any one of Examples 1-40, wherein: Structure (II) further comprises a fifth repeat unit comprising Structure (IV)

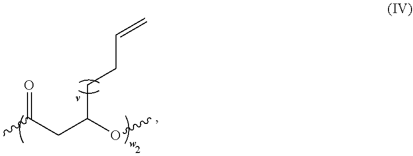

W₂ is a molar fraction of a sixth repeat unit, 0≤W₂<0.1, and (1−U₂−W₂) is a molar fraction of the fourth repeat unit.

Example 42. The composition of any one of Examples 1-41, wherein the composition is elastomeric.

Example 43. The composition of any one of Examples 1-42, further comprising a glass transition temperature (T_{g}) between −50° C. and 10° C.

Example 44. The composition of any one of Examples 1-43, wherein −39° C.≤T_{g}≤0° C.

Example 45. The composition of any one of Examples 1-44, further comprising a melting temperature (Tₘ) between 40° C. and 180° C.

Example 46. The composition of any one of Examples 1-45, wherein 56° C.≤Tₘ≤158° C.

Example 47. The composition of any one of Examples 1-46, further comprising a Young's modulus (E) between 1 MPa and 1000 MPa.

Example 48. The composition of any one of Examples 1-47, wherein 1 MPa≤E≤665 MPa.

Example 49. The composition of any one of Examples 1-48, further comprising a ductility (ε_{B}) between 1% and 500%.

Example 50. The composition of any one of Examples 1-49, wherein 10%≤ε_{B}≤333%.

Example 51. The composition of any one of Examples 1-50, further comprising a strength at break (σ_{B}) between 0.1 MPa and 20 MPa.

Example 52. The composition of any one of Examples 1-51, wherein 1.0 MPa≤σ_{B}≤16.0 MPa.

Example 53. The composition of any one of Examples 1-52, further comprising an onset of degradation temperature (T_{d,5}) between 260° C. and 300° C.

Example 54. The composition of any one of Examples 1-53, wherein 270≤T_{d,5}≤290.

Example 55. The composition of any one of Examples 1-54, wherein the composition is biodegradable.

Example 56. The composition of any one of Examples 1-55, further comprising a freshwater percent biodegradation at 90 days between 21% and 40%.

Example 57. The composition of any one of Examples 1-56, further comprising the absence of phase separation as determined by scanning electron microscopy (SEM).

Example 58. A method comprising reacting a mixture comprising a first copolymer, a second copolymer, and a crosslinker to form an elastomeric resin.

Example 59. The method of Example 58, wherein the reacting is photoinitiated.

Example 60. The method of either Example 58 or Example 59, wherein the mixture further includes a photoinitiator.

Example 61. The method of any one of Examples 58-60, wherein the photoinitiator comprises 2,2-dimethoxy-2-phenylacetophenone (DMPA).

Example 62. The method of any one of Examples 58-61, wherein the reacting is photoinitiated by irradiating the mixture with a light having a wavelength of about 365 nm.

Example 63. The method of any one of Examples 58-62, wherein the irradiating is performed for a period of time between 1 hour and three hours.

Example 64. The method of any one of Examples 58-63, wherein the first polymer comprises PHDU and the second polymer comprises PHBU.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
a first copolymer comprising a first repeat unit and a second repeat unit as defined by Structure (I) 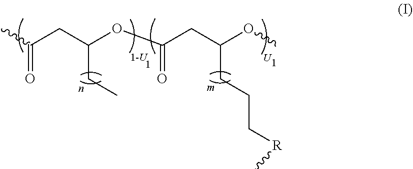
wherein: [symbol]
is a covalent bond,
U₁ is a molar fraction of the first repeat unit,
(1−U₁) is a molar fraction of the second repeat unit,
0≤n≤20, 0≤m≤20, 0<U₁≤1.0,
R is a linking group covalently linking the first copolymer to a second copolymer by the covalent bond, and
R comprises carbon, hydrogen, and sulfur.

2. The composition of claim 1, wherein the first copolymer has a molecular weight (Mₙ) between 100 kDa and 1000 kDa.

3. The composition of claim 1, wherein n is between 0 and 9, inclusively.

4. The composition of claim 1, wherein m is between 0 and 9, inclusively.

5. The composition of claim 1, wherein 0.01<U₁<0.50.

6. The composition of claim 1, wherein the first copolymer is derived from poly-R-(3-hydroxydecanonate-co-3-hydroxyundecenoate) (PHDU).

7. The composition of claim 1. wherein R comprises at least one of

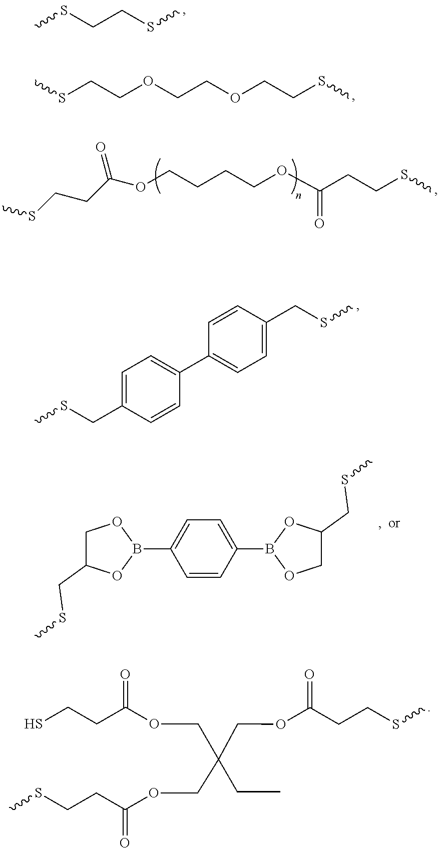

8. The composition of claim 1, wherein R is

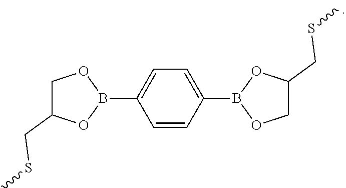

9. The composition of claim 1. wherein the second copolymer comprises Structure (I).

10. The composition of claim 1, wherein the second copolymer comprises Structure (II) 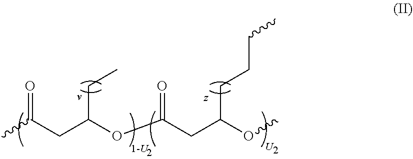
wherein:
U₂ is a molar fraction of a third repeat unit,
(1−U₂) is a molar fraction of a fourth repeat unit,
0≤v≤20, 0≤z≤20, and 0<U₂≤ 1.

11. The composition of claim 10, wherein v is between 0 and 9, inclusively.

12. The composition of claim 10, wherein z is between 0 and 9, inclusively.

13. The composition of claim 10, wherein 0.01<U₂<0.50.

14. The composition of claim 10, wherein the second copolymer chain is derived from (poly-(R)-3-hydroxyburytate-co-3-hydroxyundecanoate (PHBU).

15. The composition of claim 1, wherein the first copolymer and the second copolymer are at a mass ratio between 1:10 and 10:1 (first copolymer:second copolymer), inclusively.

16. The composition of claim 15, wherein the ratio is between 1:3 and 3:1, inclusively.

17. The composition of claim 1, wherein the composition is elastomeric.

18. The composition of claim 1, further comprising a glass transition temperature (T_{g}) between −50° C. and 10° C.

19. The composition of claim 1, further comprising a melting temperature (Tₘ) between 40° C. and 180° C.

20. The composition of claim 1, further comprising a Young's modulus (E) between 1 MPa and 1000 MPa.

21. The composition of claim 1, further comprising a ductility (ε_{B}) between 1% and 500%.

22. The composition of claim 1, further comprising a strength at break (σ_{B}) between 0.1 MPa and 20 MPa.

23. The composition of claim 1, further comprising an onset of degradation temperature (T_{d,5}) between 260° C. and 300° C.

24. The composition of claim 1, wherein the composition is biodegradable.

25. The composition of claim 24, further comprising a freshwater percent biodegradation at 90 days between 21% and 40%.

26. The composition of claim 1, further comprising the absence of phase separation as determined by scanning electron microscopy (SEM).

27. A method comprising reacting a mixture comprising a first copolymer, a second copolymer, and a crosslinker to form an elastomeric resin.
